(19) United States
(12) Patent Application Publication
(10) Pub. No.: US 2018/0276232 A1
(43) Pub. Date: Sep. 27, 2018

(54) ENHANCED ADMINISTRATIVE CONTROLS FOR A UNIFIED FILE RETENTION MANAGEMENT SYSTEM

(71) Applicant: Microsoft Technology Licensing, LLC, Redmond, WA (US)

(72) Inventors: Kannan Dhanasekaran, Redmond, WA (US); Tho Van Nguyen, Kenmore, WA (US); Le-Wu Tung, Redmond, WA (US); Nakul Garg, Sammamish, WA (US); Mingquan Xue, Redmond, WA (US); Gagandeep Kohli, Kirkland, WA (US); Dheepak Ramaswamy, Seattle, WA (US)

(21) Appl. No.: 15/469,911

(22) Filed: Mar. 27, 2017

(51) Int. Cl. G06F 17/30; H04L 29/08; G06F 3/06

(52) U.S. Cl. CPC G06F 17/30126; G06F 17/30085; G06F 17/30073; G06F 17/30557; G06F 3/0649; G06F 17/30345; G06F 17/30386; H04L 67/1097; G06F 3/067; G06F 17/30221

(57) ABSTRACT

Enhanced administrative tools for a unified file retention management system to enable selective activation of a data retention policy with respect to subsets of files across multiple productivity platforms. The system enables a user to selectively activate file management labels and/or file retention rules of a unified retention policy with respect to files that correspond to user defined filter parameters indicating subsets of files across user selected productivity platforms. Exemplary file management labels may prescribe a file retention period and a file purge age to files that have been tagged with a label. Files may be manually labeled by users and/or automatically labeled in accordance with smart label rules. The retention age threshold may be enforced for such tagged files by preventing the files from being deleted and/or modified during the file retention period. The files may automatically be purged from system storage upon reaching the file purge age.

### BACKGROUND

Organizations develop file retention policies to establish procedures for retaining information for operational or regulatory compliance purposes. For instance, an organization may develop a file retention policy to abide by government regulations that require certain financial documents to be retained for at least a predefined minimum retention period. Some conventional productivity platforms include basic administrative controls to enable creation of file retention rules that are specific to these conventional productivity platforms. Unfortunately, these basic administrative controls are unique to each individual productivity platform and lack the ability to selectively activate file management labels across multiple productivity platforms. For instance, although a conventional email platform may provide basic administrative controls to enable an administrator to develop a file retention rule with respect to a user's inbox, these basic administrative controls do not enable the file retention rule to be deployed across productivity platforms other than the conventional email platform. Stated alternatively, a file retention rule created with the conventional email platform's basic administrative controls cannot be selectively deployed across a file hosting platform, an instant messaging platform, a video conferencing platform, etc. For businesses utilizing numerous different conventional productivity platforms, successfully implementing a file retention policy across an entire organization may require policy administrators to develop and manage redundant file retention rules. Furthermore, the basic administrative controls of these conventional productivity platforms provide for only rudimentary file retention policy capabilities and do not enable creation of a single file retention rule that requires both retention and deletion of files that meet certain predefined conditions across the entire organization. For instance, a conventional email platform may be configured to deploy one file retention rule to retain certain files in a particular folder and another file retention rule to delete other files from the particular folder, but may be unable to deploy a single rule to force retention and deletion of the same files in a particular folder.

It is with respect to these considerations and others that the disclosure made herein is presented.

### SUMMARY

Techniques described herein provide enhanced administrative tools for a unified file retention management system that provides benefits over conventional file retention management systems by, for example, enabling selective activation of file management labels with respect to subsets of files across multiple productivity platforms. Generally described, configurations disclosed herein enable a system to expose a retention policy management portal (RPMP) to enable a user to selectively activate file management labels and/or file retention rules of a unified retention policy with respect to files that correspond to user defined filter parameters and, ultimately, to subsets of files across user selected productivity platforms. As used herein, a “unified retention policy” refers generally to a set of file retention rules that are configured to be deployed across multiple productivity platforms. An exemplary unified retention policy may include one or more file management labels and/or file retention rules that are configured according to a rule development scheme that is shared across various platforms of a productivity suite. As a specific example, a productivity suite may include multiple productivity platforms (e.g. a communication platform providing email and/or chat capabilities, a file hosting platform providing cloud file storage capabilities, etc.) as well as the RPMP to enable a user to develop and manage file management labels and/or file retention rules that are “unified” in the sense that individual file management labels and/or individual file retention rules can be selectively activated across multiple productivity platforms. As used herein, the term “prescribe” may refer generally to authoritatively defining policies and/or assigning policies to platforms, users, and/or groups of users. As used herein, the term “deploy” may refer generally to enforcing or otherwise bringing something into action. For example, a retention policy administrator may prescribe a unified retention policy to one or more productivity platforms and, once prescribed, one or more computing devices may deploy the unified retention policy on the one or more productivity platforms.

According to aspects of the present disclosure, a system is provided for exposing the RPMP to enable a user to develop and/or manage aspects of a unified retention policy that is configured to be deployed across multiple productivity platforms. For instance, the RPMP may enable a user to generate the unified retention policy by developing individual file management labels and individual file retention rules and then selecting various productivity platforms to prescribe the unified retention policy to. The file retention rules of the unified retention policy may define one or more actions to be performed with respect to files that satisfy certain predefined conditions. The system may further be configured to deploy the unified retention policy across the user selected productivity platforms by analyzing data corresponding to each selected productivity platform to identify files that satisfy the predefined conditions. Then, the system may cause associated actions to be performed with respect to these files. For example, a user may generate an instruction using the RPMP to prescribe the unified retention policy to both a first productivity platform and a second productivity platform. Based on the instruction, the system may scan data from each of the first productivity platform and the second productivity platform to identify corresponding sets of files that satisfy a specific predefined condition. Then, the system may cause an action corresponding to the specific predefined condition to be performed with respect to the individual files in these sets of files in the two platforms.

The RPMP may be configured to cause a computing device to display a graphical user interface (GUI) that includes various user interface elements (UIE) to enable a user to indicate filter parameters for determining a subset of files, corresponding to the various productivity platforms, for selective activation of an individual file management label and/or an individual file retention rule. As used herein, the term “selective activation” may generally refer to making a particular file retention rule and/or a particular file management label available for use and/or enforcement with respect to a particular subset of files such as, for example, a set of files stored in association with a particular user account and/or group of user accounts. The system may be configured to selectively activate individual file management labels and/or file retention rules with respect to the designated subset of files by applying the user-defined filter parameters to files stored in association with the user selected productivity platforms. In some instances, an individual file management label may be associated with both a file retention period, during which the system prevents deletion of files tagged with the file management label, and a file purge age at which the system automatically purges the particular file from productivity platform storage. For example, upon receiving a request to delete the particular file during the file retention period, the system may deny the request or otherwise prevent the particular file from being deleted notwithstanding the request to delete the particular file. Then, the system may subsequently determine that the particular file has reached the file purge age and, based thereon, automatically purge the particular file from system storage. In some instances, an individual file retention rule (which may or may not correspond to an individual file management label) may be associated with both a file retention period and a file purge age.

In various instances, the user may indicate filter parameters for determining a subset of files on the communication platform and/or the file hosting platform and, ultimately, cause one or more file management labels and/or file retention rules to be selectively activated with respect to the designated subset of files. Exemplary filter parameters include, but are not limited to, individual email accounts, groups of email accounts, individual users, and/or organizational groups that include multiple individual users. Accordingly, the RPMP may enable the user to prescribe the unified retention policy to both the communication platform and the file hosting platform but to further limit activation of the unified retention policy (and/or individual file management labels or file retention rules thereof) to a subset of these platforms' files based on the specified filter parameters. For example, a user may selectively activate a file management label with respect to only a specific organizational group including a predefined group of user accounts.

For illustrative purposes, consider a scenario where an organization provisions its employees with access to both a communication platform (e.g. an email platform and/or a chat platform) and a file hosting platform (e.g. a cloud-based file storage service). Furthermore, assume that whatever operational and/or regulatory compliance considerations apply to the communication platform also apply to the file hosting platform. For example, the organization may be required to retain tax related documents for at least a predefined period of time regardless of whether such documents reside in an email inbox or on a cloud storage folder. In such a case, the organization may develop a unified retention policy that defines, for tax related files, one or more of a file retention period, a file purge age, and/or a retention age threshold. Furthermore, the organization may further develop account data indicating a plurality of predefined organizational groups of user accounts such as, for example, a “Tax Group” within a finance department. Under these circumstances, RPMP may enable a user to prescribe a unified retention policy to both the communication platform and the file hosting platform and to further indicate filter parameters to selectively activate an individual file management label with respect to an individual predefined organizational group, e.g. the “Tax Group.”

In some instances, selectively activating the individual file management label with respect to the individual predefined organizational group causes the individual file management label to be exposed to users of the predefined organizational group. For example, the RPMP may enable a user to prescribe a tax related file retention rule to both the communication platform and the file hosting platform while selectively activating a corresponding “Tax Record” file management label with respect to the “Tax Group” only. In some instances, selectively activating a file management label to a predefined organizational group may cause the file management label to be selectively displayed to the users that are included in the predefined organizational group to enable these users to tag files with the “Tax Record” file management label. An exemplary unified retention policy (and/or individual file retention rule thereof) may define a retention age threshold at which tax related documents are to be automatically purged from the organization's data storage and below which such documents are prevented from being purged from the organization's data storage. Stated alternatively, a retention age threshold may define a single time period that corresponds to both a file retention period and a file purge age. For example, a retention age threshold may define a single file age of seven years that defines both how long the system will prevent a file from being deleted and/or modified and also defines the age at which the system will automatically delete the file. In some instances, a single file management label (or file retention rule for that matter) may be associated with a file retention period that is different than a purge age that is also associated with the single file management label. For example, a single file management label may instruct the system to retain an individual file for at least a first period of time (e.g. 3 years) and also to automatically delete the individual file after a second period of time (e.g. 5 years). Accordingly, under these circumstances a user may be able to delete the individual file after the first period of time passes and before the second period of time has passed. As used herein, a “file retention period” refers generally to a predefined file aging period during which a file that has been assigned to the file retention period will be retained by the system notwithstanding a request to delete the file. As used herein, a “file purge age” refers generally to a predefined age at which a file that has been assigned to the file purge age will be deleted from one or more storage devices by the system. As used herein, a “retention age threshold” refers generally to a predefined age of a document above which a particular action will automatically take place and below which the particular action is prevented from taking place.

It should be appreciated that, although described in relation to a system, the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates an example data flow scenario of a system that selectively activates a unified retention policy to subsets of files across multiple productivity platforms by leveraging retention policy enforcement capabilities that are built into individual ones of the multiple productivity platforms.

FIG. 1B illustrates an example data flow scenario of a system that selectively activates a unified retention policy to subsets of files across multiple productivity platforms by analyzing data corresponding to individual productivity platforms and then instructing the individual productivity platforms to perform various actions in accordance with the unified retention policy.

FIG. 1C illustrates an example data flow scenario of a system that enables users to manually label files stored on one or more productivity platforms, that automatically analyzes and labels files based on file characteristics, or both.

FIG. 2 illustrates an example data flow scenario of a system that enables users to selectively activate one or more unified retention policies with respect to various individuals, predefined organizational groups, or both.

FIGS. 3A-3G illustrates aspects of a graphical user interface (GUI) corresponding to a retention policy management portal (RPMP) that can be displayed on a device to enable a user to generate and selectively activate file retention rules. Similar to other interfaces described herein, this example GUI can be displayed on a variety of device types, such as a desktop computer, mobile device or a combination of devices.

FIG. 4 illustrates an example data flow scenario of a system that enables users to selectively activate one or more file management labels with respect to various individuals, predefined organizational groups, or both.

FIGS. 5A-5B illustrate aspects of a graphical user interface (GUI) corresponding to a retention policy management portal (RPMP) that can be displayed on a device to enable a user to generate and selectively activate file management labels.

FIG. 6A illustrates aspects of a GUI that can be displayed in association with a user account to which a particular file management label has been published to enable an information worker to manually label individual files with the particular file management label. FIG. 6B illustrates aspects of a GUI that can be displayed in association with a different user account that the particular file management label has not been published to.

FIG. 7 is a flow diagram of an illustrative process to cause a computing device to display a GUI that includes a plurality of user interface elements (UIEs) to enable the user to indicate filter parameters to selectively activate file retention rules and/or file management labels as described herein.

FIG. 8 shows additional details of an example computer architecture for a computer capable of executing a retention policy management service, a productivity platform, and/or or any program components thereof as described herein.

### DETAILED DESCRIPTION

The following Detailed Description describes techniques for providing enhanced administrative tools for a unified file retention management system that provides benefits over conventional file retention management systems by, for example, enabling selective activation of file management labels with respect to subsets of files across multiple productivity platforms. Generally described, configurations disclosed herein enable a system to expose a retention policy management portal (RPMP) to enable a user to selectively activate file management labels and/or file retention rules of a unified retention policy with respect to files that correspond to user defined filter parameters and, ultimately, to subsets of files across user selected productivity platforms. The RPMP enables a user to develop and/or manage aspects of a unified retention policy that is configured to be deployed across multiple productivity platforms. For instance, the RPMP may enable a user to generate the unified retention policy by developing individual file management labels and individual file retention rules and then selecting various productivity platforms to prescribe the unified retention policy to. The RPMP may cause a computing device to display a graphical user interface (GUI) that includes various user interface elements (UIE) to enable a user to indicate filter parameters for determining a subset of files, corresponding to the various productivity platforms, for selective activation of an individual file management label and/or an individual file retention rule. The system may be configured to selectively activate individual file management labels and/or file retention rules with respect to the subset of files by applying the user-defined filter parameters to files stored in association with the user selected productivity platforms.

For illustrative purposes, consider a scenario where an organization provisions information workers with access to both a communication platform (e.g. an email platform and/or a chat platform) and a file hosting platform (e.g. a cloud-based file storage service). Furthermore, assume that whatever operational and/or regulatory compliance considerations apply to the communication platform also apply to the file hosting platform. For example, the organization may be required to retain tax related documents for at least a predefined period of time regardless of whether such documents reside in an email inbox or on a cloud storage folder. In such a case, the organization may develop a unified retention policy that defines, for tax related files, one or more of a file retention period, a file purge age, and/or a retention age threshold. Furthermore, the organization may further develop account data indicating a plurality of predefined organizational groups of user accounts such as, for example, a “Tax Group” within a finance department. Under these circumstances, the RPMP may enable a user to prescribe a unified retention policy to both the communication platform and the file hosting platform and to further indicate filter parameters to selectively activate an individual file management label with respect to an individual predefined organizational group, e.g. the “Tax Group.” For example, the RPMP may enable a user to prescribe a tax related file retention rule to both the communication platform and the file hosting platform while selectively activating a corresponding “Tax Record” file management label with respect to the “Tax Group” only, e.g. so that only members of the “Tax Group” are enabled to use the “Tax Record” file management label.

As used herein, the term “information worker” refers generally to those individuals within an organization that are responsible for generating, reviewing, signing-off on, or otherwise interacting with files that are affected by the unified retention policy. As used herein, the term “retention policy administrator” refers generally to an individual within an organization that is responsible, in whole or in part, for generating and/or reviewing the unified retention policy. The terms “information worker” and “retention policy administrator” and “user” are not mutually exclusive, e.g. a single person may in some instances be both an information worker and a retention policy administrator.

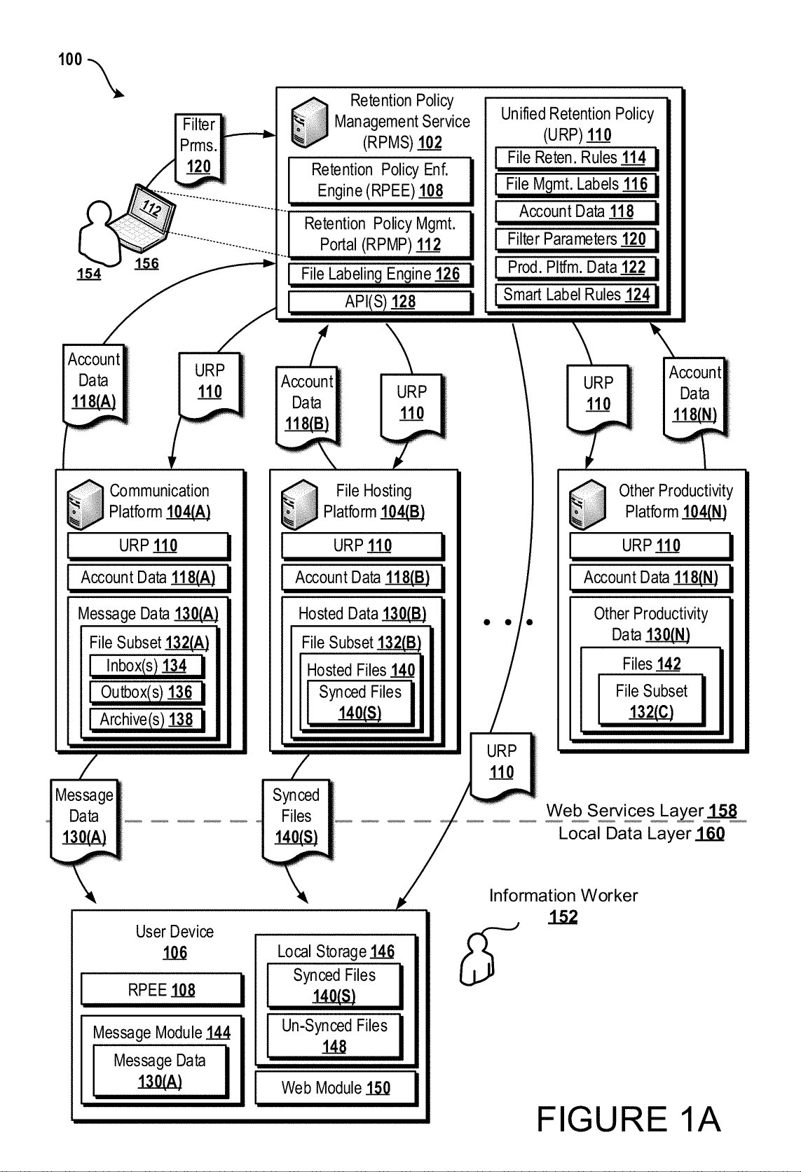

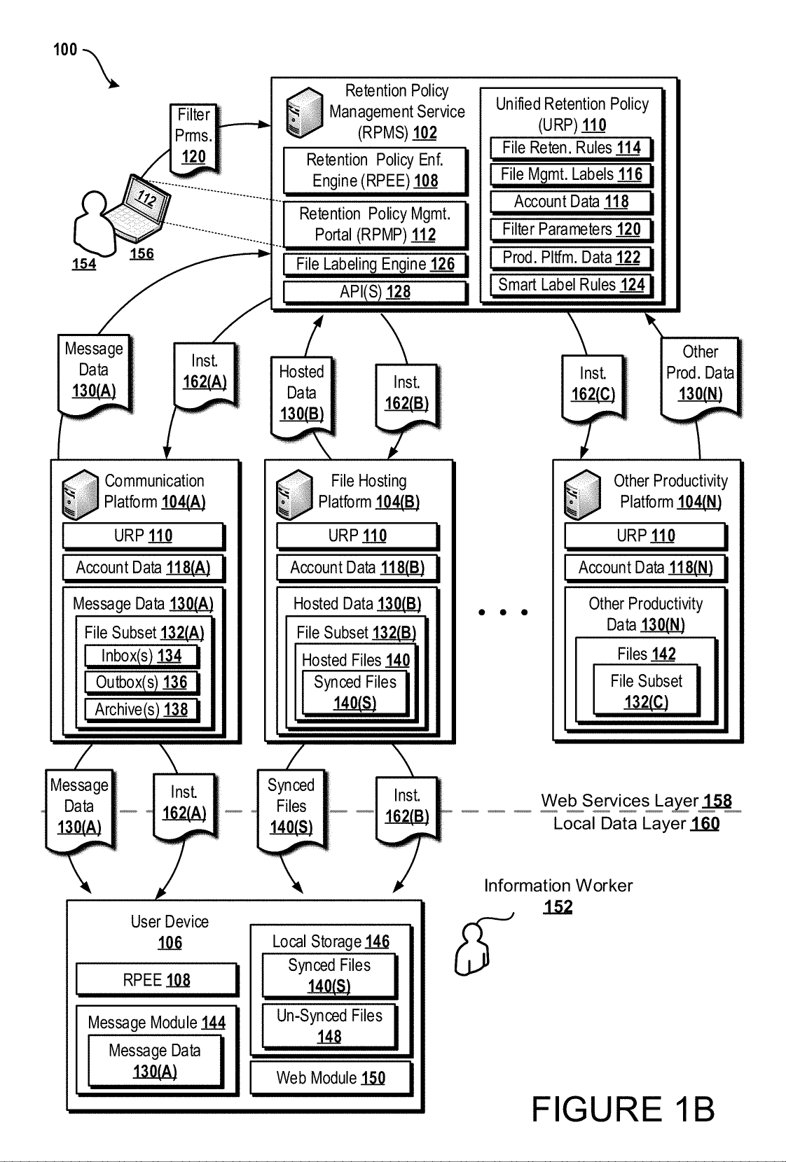

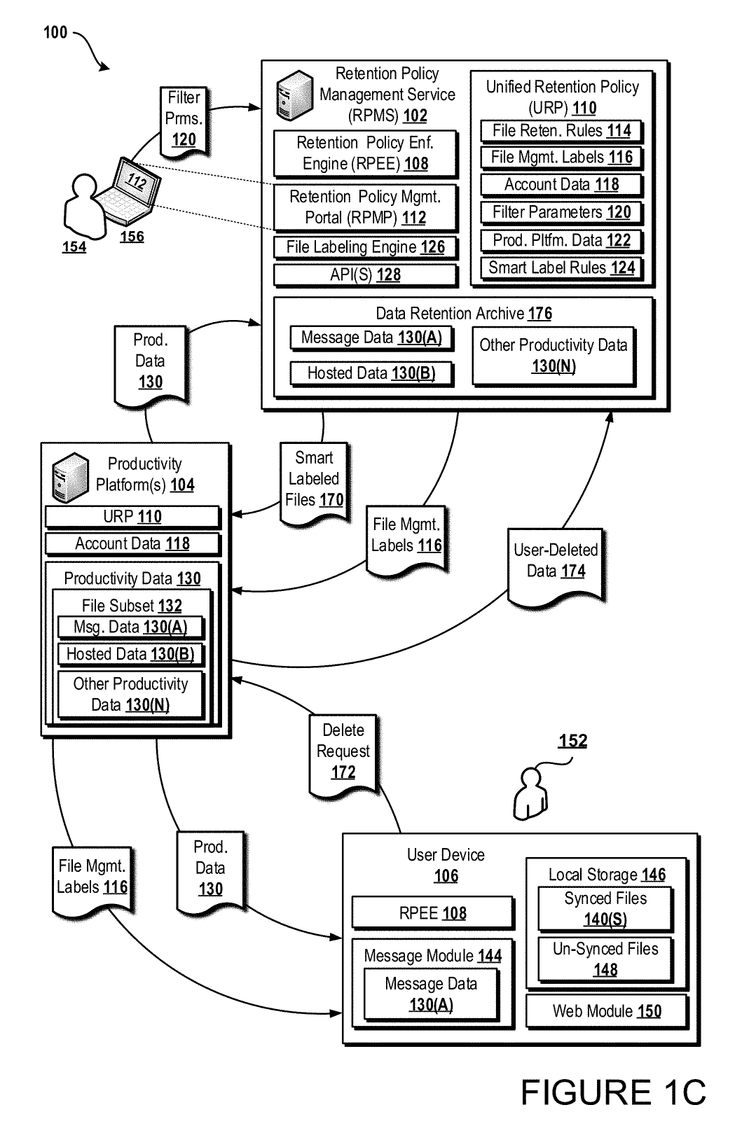

To illustrate aspects of the techniques disclosed herein: FIGS. 1A-1B illustrate various data flow scenarios of systems that selectively activate a unified retention policy to subsets of files across multiple productivity platforms; and FIG. 1C illustrates a data flow scenario of a system that automatically analyzes and labels certain classes of files stored in association with one or more productivity platforms. Similar to other illustrations described herein, it can be appreciated that operations and/or functionalities may be described according to a logical flow of data between various components. The order in which these operations and/or functionalities are described and/or illustrated herein is not intended to be construed as a limitation. Rather, any number of the operations and/or functionalities described with respect to any one of FIGS. 1A-1C, may be combined in any order and/or in parallel in accordance with the present disclosure. Other processes and/or operations and/or functionalities described throughout this disclosure shall be interpreted accordingly.

Turning now to FIG. 1A, an example data flow scenario is illustrated with respect to a system 100 that selectively activates a unified retention policy to subsets of files across multiple productivity platforms by leveraging retention policy enforcement capabilities that are built into individual ones of the multiple productivity platforms. As used herein, the term “productivity platform” refers to local and/or web-based software that is dedicated to producing, modifying, and/or accessing information such as, for example, email, live chat sessions, word processing documents, presentations, workbooks (a.k.a. “worksheets”), and/or Internet/Intranet share sites. Exemplary productivity platforms include, but are not limited to, communication platforms (e.g. email services, instant messaging services, on-line video chat services, etc.) and file hosting platforms (e.g. personal cloud based storage, online file sharing services). Furthermore, in some implementations, the individual productivity platforms may be components of a productivity suite (e.g. GOOGLE G-SUITE, ZOHO Office Suite, or MICROSOFT OFFICE 365) such that a single set of user credentials may be issued to provision a user with access to a plurality of different productivity platforms. As illustrated, the system 100 may include a retention policy management service 102 that may transmit a unified retention policy to multiple productivity platforms 104. The system 100 may further include a user device 106 through which an information worker may access the multiple productivity platforms 104. As illustrated in FIG. 1A, exemplary productivity platforms may include, but are not limited to, a communication platform 104(A), a file hosting platform 104(B), and any other type of productivity platform 104(N). In some instances, the file hosting platform 104(B) may be configured to enable a user to open, view, edit, create, save, copy, or otherwise manipulate files such as, for example, text documents, spreadsheet documents, and/or presentation documents. Exemplary file hosting platforms include, but are not limited to, POWERPOINT ONLINE, MICROSOFT ONEDRIVE, GOOGLE DOCS, GOOGLE SHEETS, GOOGLE SLIDES, and/or GOOGLE DRIVE.

The retention policy management service 102 may include a retention policy enforcement engine (RPEE) 108 that is configured to enforce a unified retention policy (URP) 110 to subsets of files across one or more of the productivity platforms 104. The retention policy management service 102 may be configured to expose a retention policy management portal (RPMP) 112 to enable an administrator to input filter parameters to prescribe the unified retention policy 110 to individual ones of the productivity platforms 104 and/or individual user accounts.

The unified retention policy 110 may include, but is not limited to, file retention rules 114 that define various actions to be performed with respect to files that satisfy one or more predefined conditions and/or are tagged with one or more file management labels 116 in accordance with the unified retention policy 110. In some instances, an individual file management label 116 may be associated with one or more file retention rules 114 to cause the system to perform actions with respect to tagged files. For example, the unified retention policy 110 may include a “Tax Record Policy” file retention rule 114 that expressly prescribes a retention age threshold for files that are determined to be tax related. Furthermore, a “Tax Record” file management label may be associated with the “Tax Record” file retention rule to cause this rule to be performed with respect to files that are tagged with the “Tax Record” file management label. The retention policy enforcement engine 108 may enforce the unified retention policy 110 across the communication platform 104(A) and the file hosting platform 104(B) by identifying (and/or causing the communication platform 104(A) and the file hosting platform 104(B) to identify) tax related documents. The system 100 may then automatically purge these documents from data storage associated with the productivity platforms 104 as individual ones of the tax related documents reach the retention age threshold.

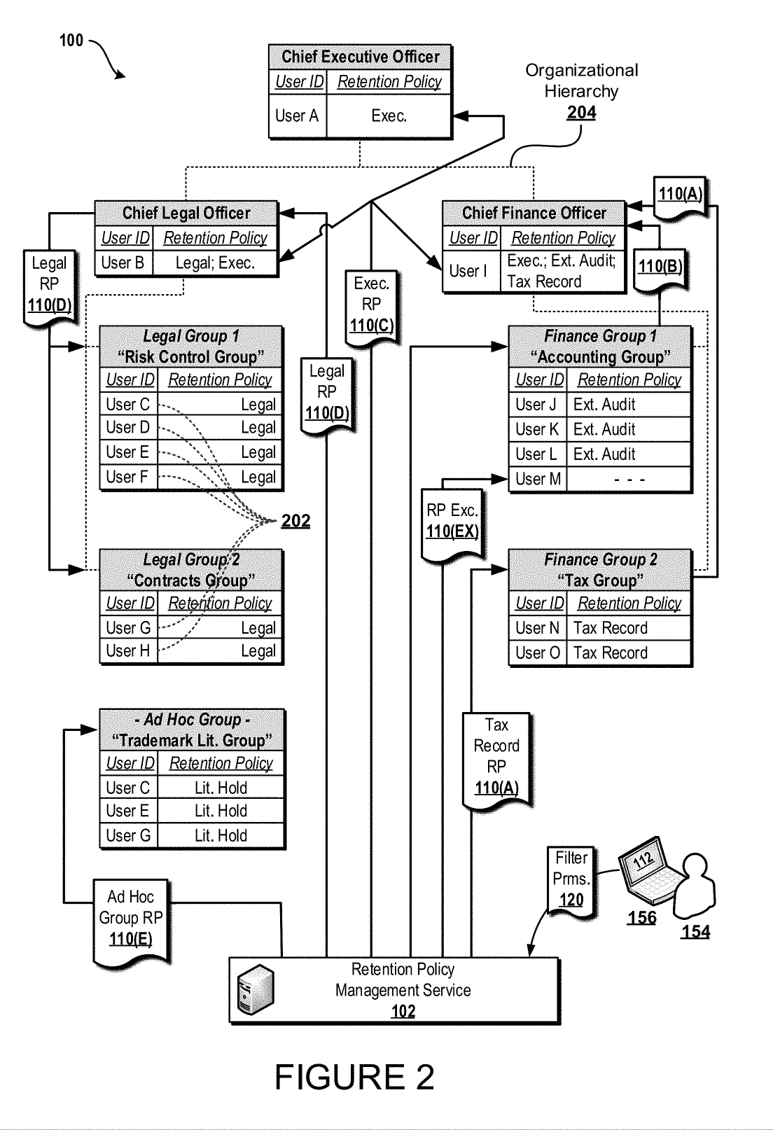

The unified retention policy 110 may further include account data 118 that is associated with productivity platform user accounts assigned to individual and/or groups of information workers. For example, the organization may provision information workers with access to one or more of the productivity platforms 104 by assigning the information workers with unique credentials that can be used to sign-into associated productivity platform user accounts. In some instances, the account data 118 may indicate one or more predefined organizational groups that include a plurality of productivity platform user accounts. For example, as will be discussed in more detail with relation to FIG. 2, the account data 118 may indicate various organizational groups that may be associated with an organizational hierarchy.

In some instances, the RPMP 112 may enable an administrator to indicate filter parameters 120 for selectively activating file retention rules 114 and/or file management labels 116 with respect to one or more subsets of files. For example, the RPMP 112 may enable an administrator to indicate filter parameters 120 to prescribe a file management label 116 to both the communication platform 104(A) and the file hosting platform 104(B). The filter parameters 120 may further cause the system 100 to analyze a plurality of files stored in association with the communication platform 104(A) and the file hosting platform 104(B) to identify a subset of files based on the filter parameters 120. In some instances, the filter parameters 120 may instruct the system 100 to prescribe aspects the unified retention policy 110 across multiple productivity platforms but to selectively activate these aspects of the unified retention policy 110 with respect to some but not all of the files stored in association with these multiple productivity platforms. For example, the filter parameters 120 may instruct the system 100 to prescribe a file retention rule across multiple platforms but to selectively activate the file retention rule with respect to an individual user account and/or a predetermined organizational group.

The unified retention policy 110 may further include productivity platform data 122 that is associated with individual ones of the multiple productivity platforms 104. In some implementations, the system 100 may obtain productivity platform data corresponding to each of the communication platform 104(A) and the file hosting platform 104(B). Exemplary productivity platform data includes, but is not limited to, computer readable instructions that enable the system to navigate an organizational scheme of the productivity platforms and/or analyze different data file types that are associated with various productivity platforms. For example, the productivity platform data may inform the system of an organizational scheme used by a productivity platform to store productivity data such as, for example, emails and word processing documents. As another example, the productivity platform data may enable the system to read, modify, and/or analyze an email file type (e.g. a Personal Storage Table file and/or an HTML email file) that is associated with the communication platform as well as a word processing file type (e.g. an Office Open XML Document) and/or a spreadsheet file type (e.g. an Office Open XML Workbook) that is associated with the file hosting platform. The system may further determine a unified retention policy that associates one or more actions (e.g. deleting a file) with various predefined conditions (e.g. the file meeting or exceeding a retention age threshold and/or a file purge age). The system may also expose the RPMP to enable a user to prescribe the unified retention policy to both the communication platform and the file hosting platform.

The unified retention policy 110 may further include smart label rules 124 to enable a file labeling engine 126 to analyze files stored in association with the productivity platforms 104 and, ultimately, to automatically label individual files without manual input from an information worker. For example, the file labeling engine 126 may be configured to analyze files with respect to one or more conditions defined by a particular smart label rule 124 and, ultimately, to automatically tag individual files that satisfy the one or more conditions with a corresponding label. As a more specific example, suppose that a “Tax Record” smart label rule 124 is configured to identify tax related files and then to tag these tax related files with a “Tax Record” file management label. The “Tax Record” smart label rule 124 may include a condition associated with one or more predetermined keywords for the file labeling engine 126 to search for in a file header. For example, the file labeling engine 126 may identify files including the term “IRS Form” within a one inch margin from the top of the page and tag files that satisfy this condition with the “Tax Record” file management label.

The retention policy management service 102 may further include one or more application programming interfaces (API) 128 that expose an interface through which the retention policy management service 102 can send data to and/or receive data from the productivity platforms 104 and/or the user device 106. Through the use of this data interface and other interfaces, the devices and services described herein can communicate and process data in such a manner as to enable the functionality and/or operations disclosed herein.

The productivity platforms 104 may include productivity data 130 that includes a plurality of files that are scattered across the productivity platforms 104 and which are potentially subject to one or more retention rules 114 of the unified retention policy 110. For example, the communication platform 104(A) may include message data 130(A) associated with an email or other type of communication account whereas the file hosting platform 104(B) may include hosted data 130(B) corresponding to a cloud storage drive. Individual files of the plurality of files of the productivity data 130 may include one or more characteristics that can be exploited to parse the productivity data 130 into one or more file subsets 132. For example, the filter parameters 120 may be set to cause the system 100 to parse the productivity data 130 into a file subset 132 that includes files that are stored in association with user accounts included in a predetermined organizational group. For example, the filter parameters 120 may cause the system 100 to parse the productivity data 130 to identify a file subset that corresponds only to a tax group. For purposes of the present discussion, assume that the communication platform 104(A) includes message data 130(A) corresponding to one or more email inboxes 134, one or more email outboxes 136, and/or one or more archive folders 138. Further assume that the file hosting platform 104(B) includes hosted data 130(B) corresponding to one or more hosted files 140 which may include one or more synced files 140(S) (e.g. files that are synchronized between the user device 106 and a productivity platform 104), and that the other productivity platform 104(N) includes other productivity data 130(N) including one or more files 142 that are also potentially subject to the unified retention policy 110.

The user device 106 may also include the retention policy enforcement engine 108 (or a version thereof) that is configured to enforce the unified retention policy 110 with respect to portions of the productivity data 130 that are stored locally at the user device 106. For example, the retention policy enforcement engine 108 may be configured to access a message module 144 to analyze locally stored portions of the message data 130(A), and also to access local storage 146 of the user device 106 to analyze the synced files 130(S) and/or the plurality of un-synced files 148 (e.g. files that are stored locally on the user device 106 and are not synchronized with a productivity platform 104). The user device 106 may further include a web module 150 through which an information worker 152 can access individual ones of the productivity platforms 104. For example, one or more of the productivity platforms 104 may include a web-based portal through which the information worker 152 can provide her organization assigned user credentials to obtain access to the productivity data 130 that is associated with her account.

With respect to the example data flow scenario of FIG. 1A, the retention policy management service 102 is shown to obtain account data 118 corresponding to user accounts that are provisioned with access to the productivity platforms 104. In some implementations, various portions of the account data 118 may correspond to individual productivity platforms 104. For example, the account data 118 may be comprised of account data 118(A) that corresponds to the communication platform 104(A), account data 118(B) that corresponds to the file hosting platform 104(B), and so on. Exemplary account data includes, but is not limited to, user credentials associated with the information worker 152, and account settings corresponding to a user account of the information worker 152. In some implementations, the account data 118(A) and the account data 118(B) may share similar user credentials data while having at least partially divergent account settings data. For example, the same user credentials may provision the information worker 152 with access to each of the communication platform 104(A) and the file hosting platform 104(B) but the information worker 152 may have customized her account settings with respect to one or both of the communication platform 104(A) and the file hosting platform 104(B). Although as illustrated, the retention policy management service 102 is shown to receive the account data 118(A)-118(N) from the corresponding productivity platforms 104(A)-104(N), it can be appreciated that the account data 118 may be obtained from alternate sources such as, for example, an administrative database.

The retention policy management service 102 may expose the RPMP 112 to enable a retention policy administrator 154 to view and/or modify the unified retention policy 110 in general and/or as related to specific user accounts. For example, the RPMP 112 may be configured to cause a computing device 156 to display various aspects of the unified retention policy 110 such as, for example, the file retention rules 114, the account data 118, and/or the productivity platform data 122. The RPMP 112 may further be configured to enable the retention policy administrator 154 to create new and/or modify existing file retention rules 114. Through the RPMP 112, the retention policy administrator 154 may define a particular file retention rule that includes at least one condition and at least one action to be performed with respect to files that satisfy the at least one condition. Exemplary conditions include, but are not limited to: reaching and/or exceeding a file purge age as measured from a date of creation of a particular file; reaching and/or exceeding a file purge age as measured from a date that a particular file was last modified; reaching and/or exceeding a retention age threshold as measured from a date of creation or a date a file was last modified; an age of the file being within a file retention period; being manually tagged by a user with a label (e.g. a “Tax Record” label indicating that a particular file is tax related); and/or being automatically tagged by the system 100 with a label. Exemplary actions to be performed with respect to files that satisfy one or more conditions include, but are not limited to, forcibly retaining a particular file within system storage (e.g. preventing a user from deleting the file), moving a particular file to an archive, purging a particular file from system storage, preventing a particular file from being displayed to the information worker 152 via one or more of the productivity platforms 104, preventing a particular file from being modified by the information worker 152, and/or prompting a user (e.g. the retention policy administrator 154 and/or the information worker 152) to indicate whether to retain and/or purge a particular file. Exemplary file retention rules include, but are not limited to, automatically purging a particular file from storage associated with the productivity platforms 104 based on the particular file reaching or exceeding a file purge age and/or retention age threshold, forcibly retaining a particular file in storage associated with the productivity platforms 104 (and/or a data retention archive) based on the particular file not reaching the retention age threshold and/or the file age being within the file retention period, and/or prompting a user to adjudicate whether to delete or retain a particular file upon that file reaching a retention age threshold.

In some implementations, a file retention rule may be associated with a purge review age to cause the system 100 to prompt a human review such as, for example, the information worker 152 to indicate whether to purge individual files as these files reach the purge review age. For example, the system 100 may identify one or more files that have reached the purge review age and, based thereon, trigger a human reviewer to indicate whether the one or more files are to be purged. In some implementations, a particular file retention rule may be associated with both a file purge age as well as a purge review age that is less than or equal to the file purge age. As a more specific, but nonlimiting example, an individual file retention rule may be associated with a file purge age of nine years and a purge review age of eight years and eleven months. Under these circumstances, the system may determine that an individual file has reached the purge review age once that file reaches eight years and eleven months of age and, ultimately, the system 100 may prompt a human to indicate whether to purge the individual file upon that individual file reaching the file purge age of nine years. Furthermore, in some implementations, the system will refrain from automatically purging individual files in the absence of a user indication to do so. Stated alternatively, in some implementations, automatically purging individual files may be contingent upon an indication from a human reviewer that purging these individual files is appropriate.

In some implementations, the system may be configured to determine a user access frequency for particular files that are associated with a file management label and have reached a file purge age. For example, the system may determine that a particular file that has reached its file purge age has been accessed within a predetermined threshold of time (e.g. has been accessed within the last one day, one week, one month, one year, etc.) and, based on this determination, the system may prevent individual files from being automatically purged from system storage. Accordingly, the system may intelligently prevent files that are still being frequently accessed from being automatically purged.

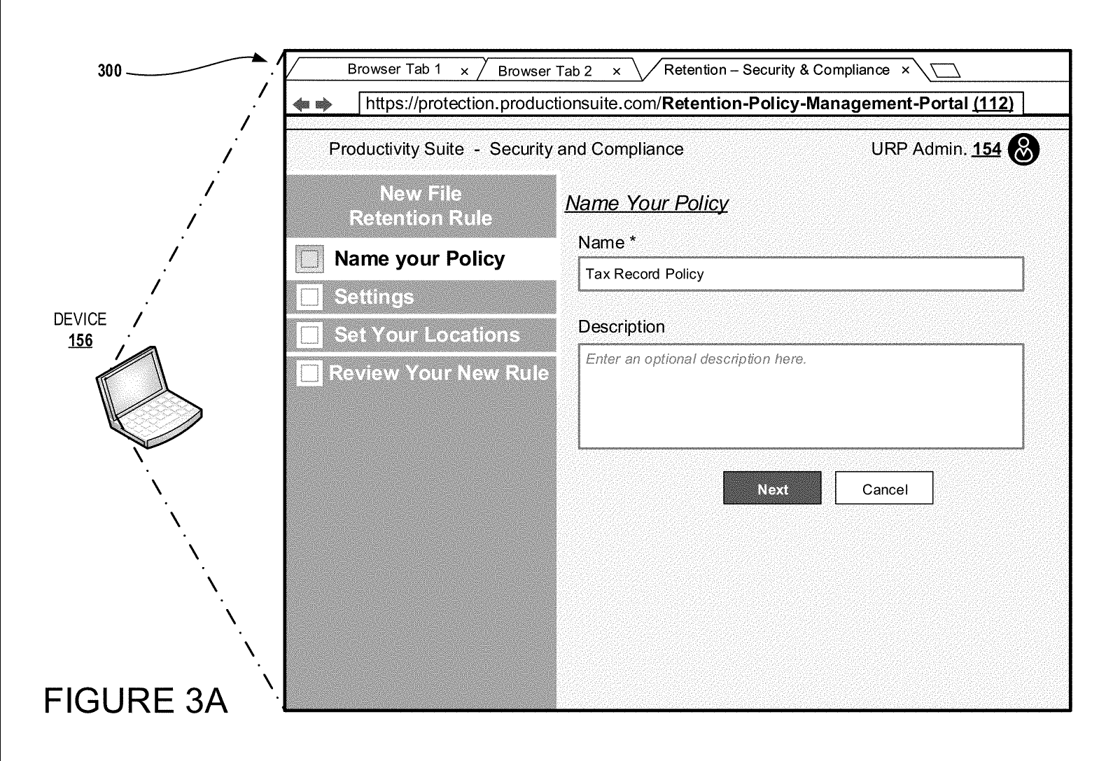

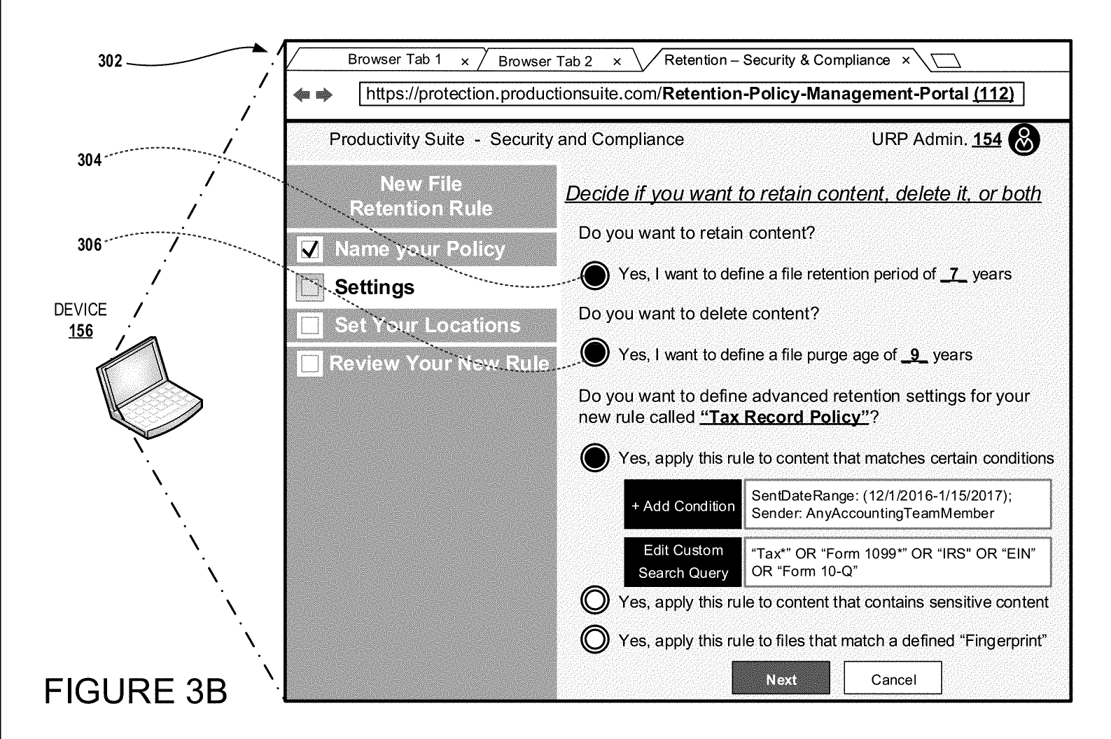

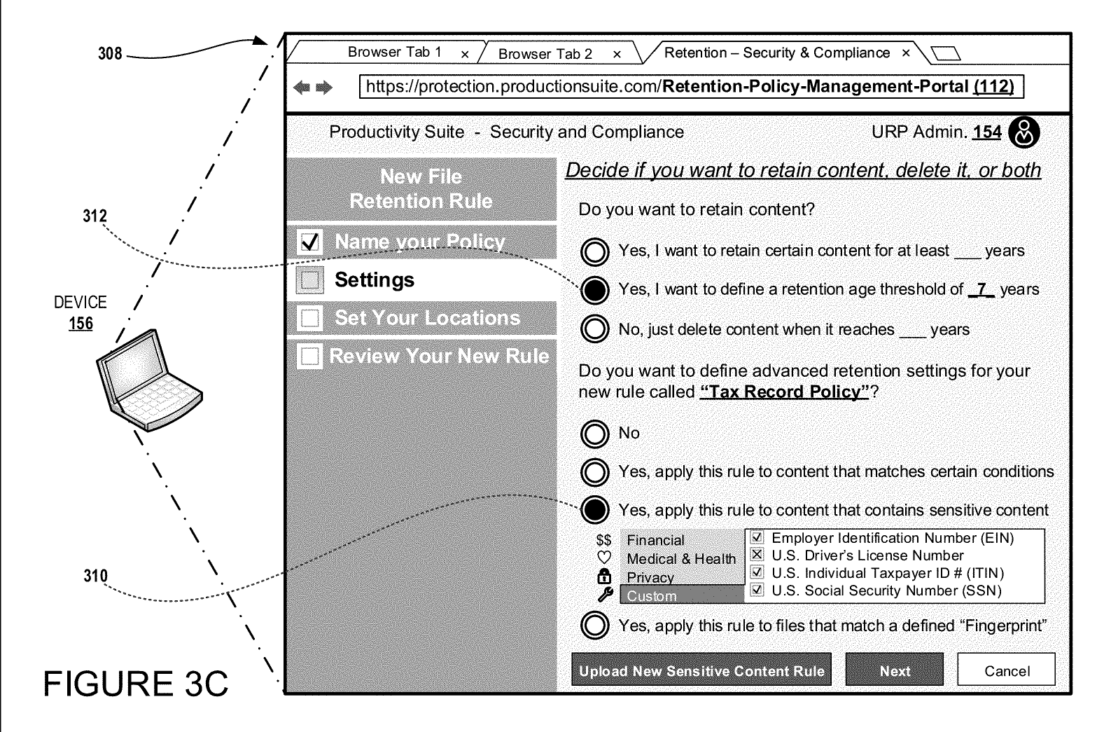

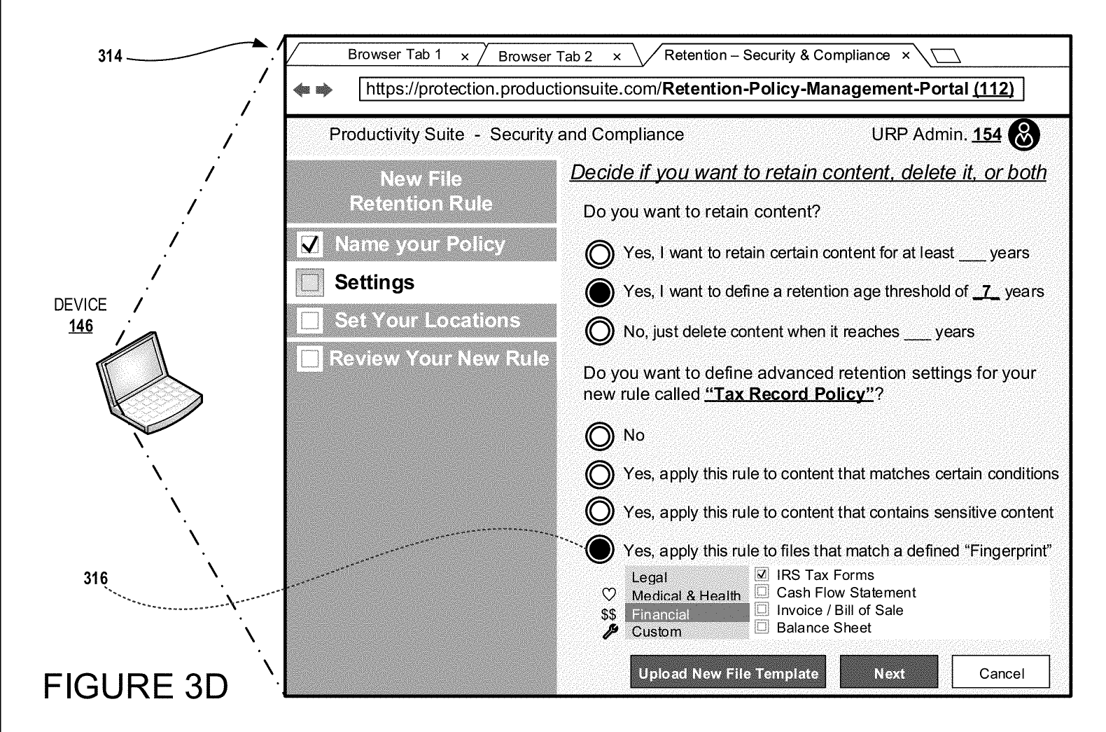

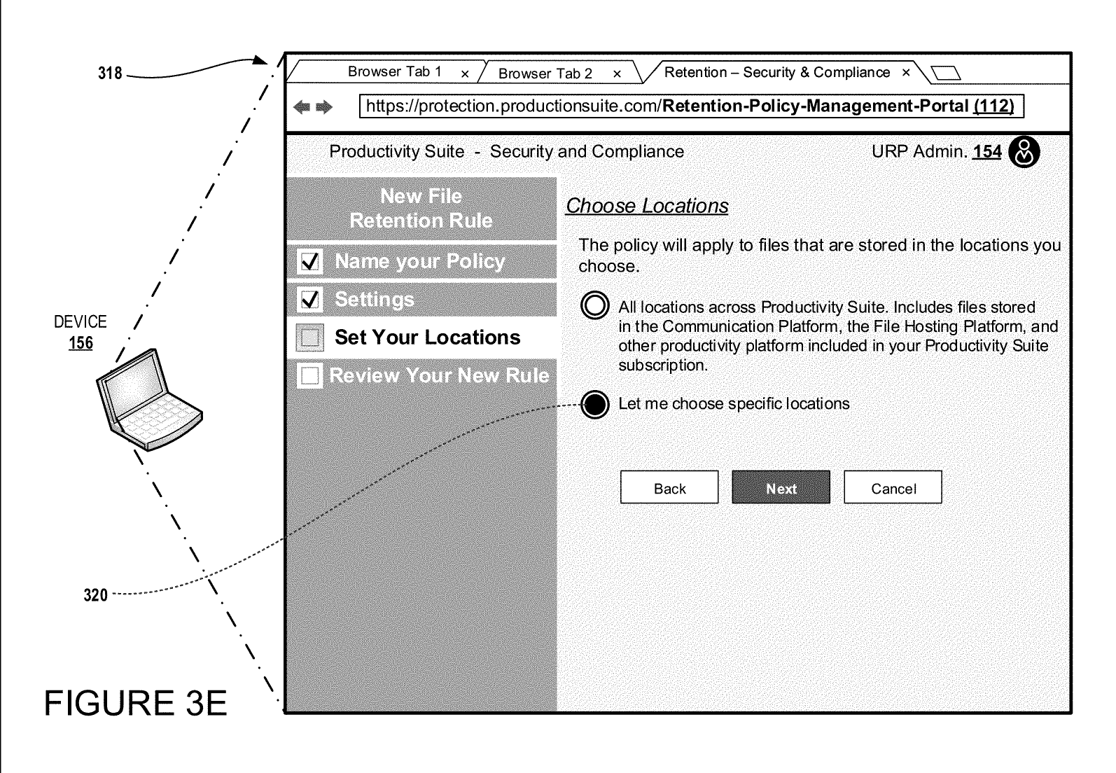

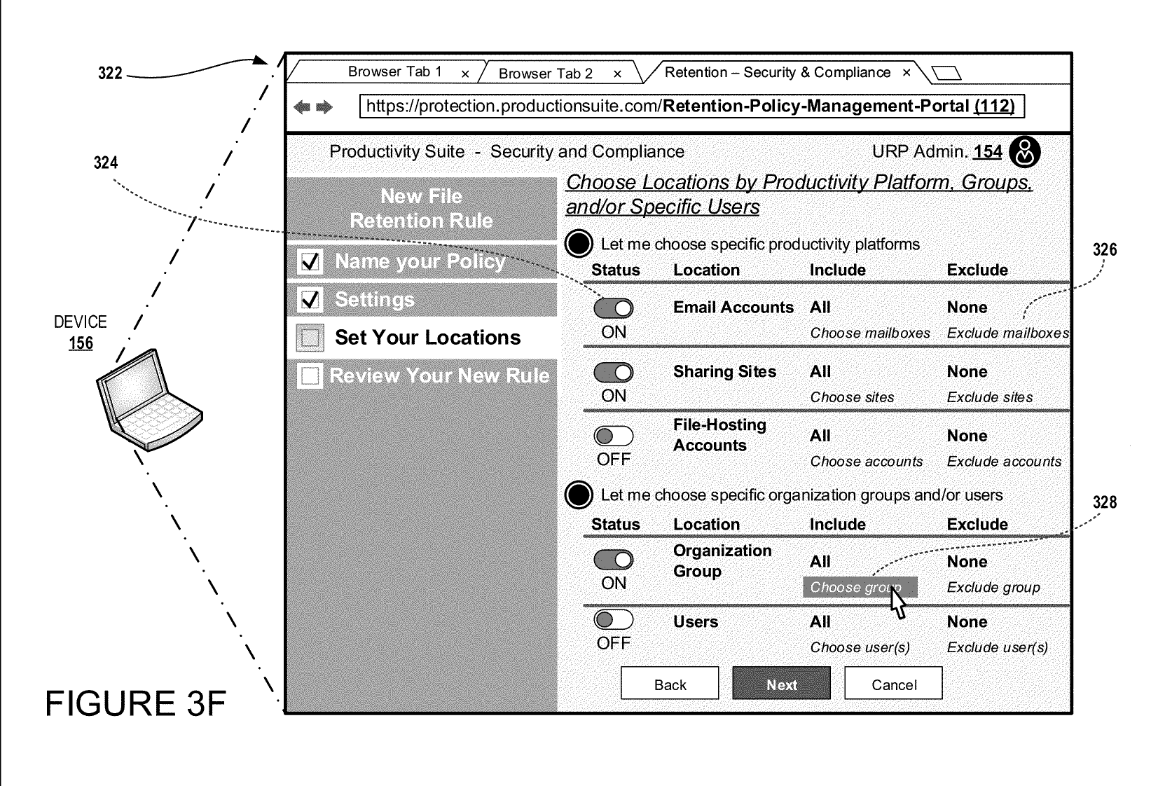

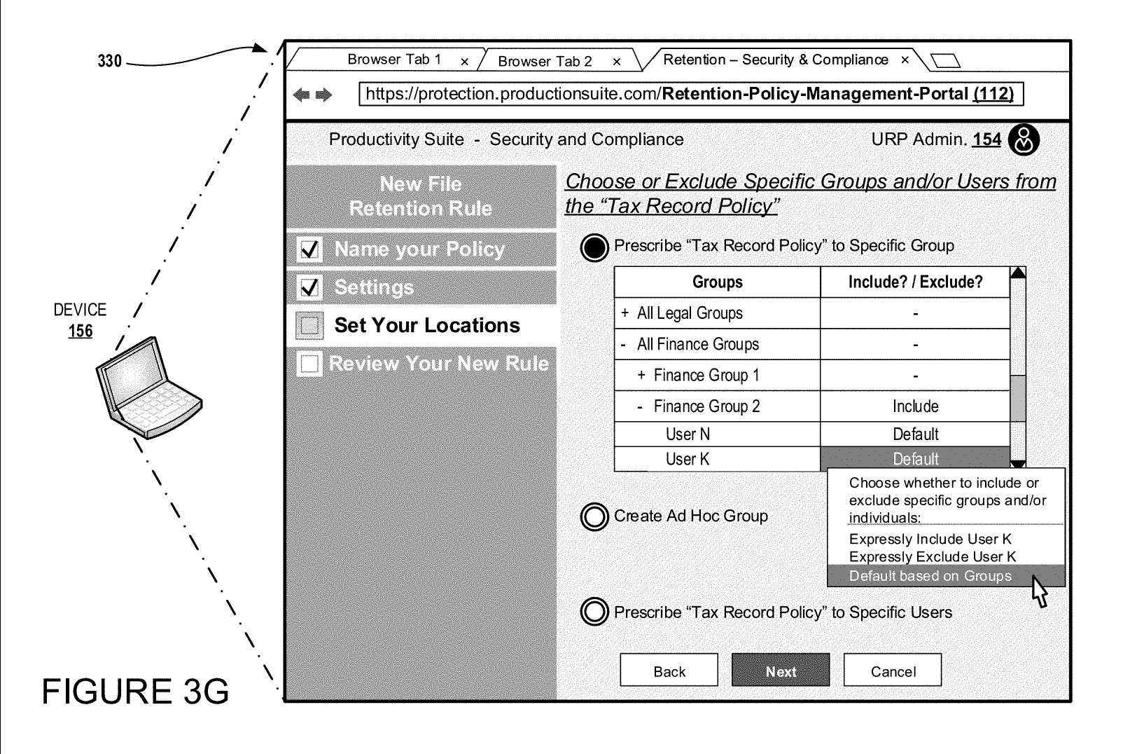

The RPMP 112 may enable the retention policy administrator 154 to indicate the filter parameters 120 and to cause the computing device 156 to transmit the filter parameters 120 to the retention policy management service 102. The filter parameters 120 may enable the system 100 to determine one or more file subsets 132, of the productivity data 130, for selective activation of one or more file management labels 116 and/or file retention rules 114. For example, although the message data 130(A) may include hundreds or even thousands of individual email accounts, the retention policy administrator 154 may indicate filter parameters 120 that cause the system 100 to selectively activate a “Tax Record” file management label with respect to only those email accounts held by members of a “Tax Group” within a finance department but not with respect to any other predefined organizational groups. Under these circumstances, the file subset 132(A) may correspond to email messages (and electronic attachments thereof) that are stored within inboxes 134, outboxes 136, and email archives 138 of the “Tax Group” members. Furthermore, just as some filter parameters 120 may indicate which files of the productivity data 130 should be included in the one or more file subsets 132, other filter parameters 120 may indicate which files of the productivity data 130 should be excluded from the one or more file subsets 132. For example, as will be discussed in more detail with respect to FIG. 3G, the filter parameters 120 may include a parameter that indicates inclusion of all files stored in association with a predetermined organizational group's user accounts (all of the “Tax Group's” emails), and another parameter that indicates exclusion of files stored in association with one or more expressly defined members of this predetermined organizational group.

In various instances, the filter parameters 120 may also enable the retention policy administrator 154 to prescribe the unified retention policy 110 across multiple ones of the productivity platforms 104. For example, the filter parameters 120 may cause the retention policy management service 102 to transmit the unified retention policy 110 to a plurality of user-selected productivity platforms 104. Ultimately, the filter parameters 120 may cause one or more aspects of the unified retention policy 110 to be deployed (e.g. enforced) at each user-selected productivity platform 104. Although as illustrated, the retention policy management service 102 is shown to transmit the unified retention policy 110 to each of the communication platform 104(A), the file hosting platform 104(B), and the other productivity platform 104(N), in some implementations the RPMP 112 may enable the retention policy administrator 154 to prescribe the unified retention policy 110 to some but not all of the productivity platforms 104. For example, in some implementations, the retention policy administrator 154 may utilize the RPMP 112 to indicate filter parameters 120 to prescribe the unified retention policy 110 across multiple ones of the productivity platforms 104 while excluding one or more individual productivity platforms 104 from all or part of the unified retention policy 110. For example, via the RPMP 112, the retention policy administrator 154 may modify filter parameters 120 to prescribe the unified retention policy 110 to all productivity platforms 104 by default, while further modifying the filter parameters 120 to override the default by excluding selected ones of the productivity platforms 104.

In some implementations, default parameters of the unified retention policy 110 may prescribe the unified retention policy 110 to a predefined subset of the productivity platforms 104. For example, an organization may elect that a particular form of communication be transitory and, therefore, elect not to save messages transmitted via this particular form of communication. To illustrate, suppose that the communication platform 104(A) corresponds to an email service (e.g. MICROSOFT OUTLOOK, GMAIL, etc.) and the other productivity platform 104(N) corresponds to a video conferencing service (e.g. SKYPE, GOOGLE HANGOUTS). Here, an organization may elect to deploy the unified retention policy with respect to the email service but refrain from retaining any communications associated with the video conferencing service. Under these circumstances, the organization may set parameters of the system 100 that by default prescribe the unified retention policy 110 to the email service while excluding the video conferencing service from the unified retention policy 110.

In some implementations, the RPMP 112 may also enable the retention policy administrator 154 to indicate filter parameters 120 that selectively prescribe the unified retention policy 110, in whole or in part, to user accounts on an individual and/or group basis. For example, a version of the unified retention policy 110 may be created with respect to an accounting team of an organization and the RPMP 112 may enable the retention policy administrator 154 to seamlessly prescribe this version of the unified retention policy 110 to the accounting team as a whole rather than having to select each individual member of the accounting team. As another example, the retention policy administrator 154 may generate one or more file retention rules 114 to be uniquely prescribed to one or more user accounts on an individual basis. As a more specific, but nonlimiting example, the unified retention policy 110 may by default cause all tax related files to be automatically purged from the system 100 across all of the productivity platforms 104 upon these tax related files reaching a predetermined file purge age. However, the retention policy administrator 154 may modify the default system parameters with respect to one or more specific information workers (e.g. an executive level organization employee such as a Chief Financial Officer) to prompt a user to adjudicate whether to delete or retain any of this specific information worker's tax related files that reach the file purge age.

In some implementations, the RPMP 112 may enable the retention policy administrator 154 to selectively exclude individual communication platform user accounts from a portion of the unified retention policy 110 and/or the entire unified retention policy 110. For example, the system 100 may obtain organization account data that corresponds to user accounts that are provisioned by the organization with access to two or more productivity platforms. To illustrate, suppose that the organization account data includes information associated with a particular user account that is provisioned by the organization with access to the communication platform 104(A) and the file hosting platform 104(B). Stated alternatively, the particular user is provisioned with two accounts (which may share common user credentials) where account “A” corresponds to the communication platform 104(A) and account “B” corresponds to the file hosting platform 104(B). Under these circumstances, the RPMP 112 may enable the retention policy administrator 154 to generate filter parameters 120 to select either account “A” or account “B” (or both for that matter) to be excluded in whole or in part from the unified retention policy. Then, based on the retention policy administrator's selected account exclusions, the system 100 may exclude account “A” and/or account “B” from the unified retention policy 110.

Based on the filter parameters 120 defined by the retention policy administrator 154 via the RPMP 112, the system 100 may deploy the unified retention policy 110 across one or more of the productivity platforms 104. For example, in the implementation illustrated in FIG. 1A, the retention policy management service 102 is shown to transmit the unified retention policy 110 to individual productivity platforms 104 to cause the individual productivity platforms to enforce the unified retention policy 110. For example, the system 100 may leverage retention policy enforcement capabilities that are built into individual ones of the multiple productivity platforms 104. Under these circumstances, the system 100 may automatically modify retention policy settings of the individual productivity platforms 104 based on the unified retention policy 110. For example, the system 100 may transmit user-defined filter parameters 120 associated with the communication platform 104(A) to the communication platform 104(A) and also transmit user-defined filter parameters 120 associated with the file hosting platform 104(B) to the file hosting platform 104(B). Based on those filter parameters 120 that correspond to each individual productivity platform 104, these individual productivity platforms may analyze corresponding productivity data 130 based on the filter parameters 120 to identify a corresponding file subset 132. Then, the individual productivity platforms 104 may each analyze its corresponding file subset 132 to identify files that satisfy various conditions of the unified retention policy 110 and, in particular, individual file retention rules 114 thereof. Once the individual productivity platforms 104 identify files, within the file subset 132, that satisfy conditions of the unified retention policy 110, these individual productivity platforms 104 may then perform actions corresponding to applicable ones of the file retention rules 114.

To further illustrate these concepts, in the implementation illustrated in FIG. 1A, the communication platform 104(A) may analyze the message data 130(A) based on the filter parameters 120 to identify those emails that correspond to the file subset 132(A) and the file hosting platform 104(B) may analyze the hosted data 130(B) based on the filter parameters 120 to identify one or more document and/or workbook files that correspond to the file subset 132(B), and so on. For example, suppose that the filter parameters 120 are set to cause the system 100 to selectively activate a “Tax Record Policy” file retention rule 114 with respect to the “Tax Group's” user accounts. Under these circumstances, the filter parameters 120 may cause the communication platform 104(A) to selectively activate the “Tax Record Policy” file retention rule 114 with respect to the “Tax Group's” email files, e.g. file subset 132(A), and further cause the file hosting platform 104(B) to selectively activate the “Tax Record Policy” file retention rule 114 with respect to the “Tax Group's” cloud-based file storage accounts (e.g. MICROSOFT ONEDRIVE and/or GOOGLE DRIVE accounts), e.g. file subset 132(B). Then, once the filter parameters 120 have been used to identify the file subsets 132, the individual productivity platforms 104 may analyze these file subsets 132 to identify one or more files that satisfy conditions corresponding to one or more file retention rules 114 and/or smart label rules 124. For example, the communication platform 104(A) may analyze the file subset 132(A) to identify one or more email files that satisfy conditions corresponding to the “Tax Record Policy” file retention rule 114, the file hosting platform 104(B) may analyze the file subset 132(B) to identify one or more document and/or workbook files that satisfy conditions corresponding to the “Tax Record Policy” file retention rule 114, and so on. Then, the communication platform 104(A) may perform a corresponding action with respect to the one or more email files that satisfy conditions of the “Tax Record Policy” file retention rule 114, and the file hosting platform 104(B) may likewise perform this action with respect to the one or more document and/or workbook files that satisfy the conditions of the “Tax Record Policy” file retention rule 114.

As further illustrated in FIG. 1A, in some implementations, the unified retention policy 110 may be transmitted to the user device 106 to cause a local version of the retention policy enforcement engine 108 to enforce the unified retention policy 110 with respect to the message module 144 and/or the local storage 146. Although the user device 106 may include a web module 150 that can be used to access the productivity platforms 104 (e.g. by providing her credentials to the productivity platforms via a web browser), the user device 106 may also be configured to periodically synchronize local data with one or more of the communication platforms. For example, the message module 144 may be a local email client (MICROSOFT'S OUTLOOK, APPLE'S IOS MAIL) that is configured to provide non-web-based access to the information worker's user account for the communication platform 104(A). Accordingly, the message module 144 may store at least some of the message data 130(A) locally at the user device 106. Furthermore, the local storage 146 may be configured to periodically receive the synchronized files 140(S) from the file hosting platform 104(B) to enable the information worker 152 to access these synchronized files 140(S) without having to use the web module 150 to access the file hosting platform 104(B) via the web services layer 158. Accordingly, to mitigate a risk that enforcement of the unified retention policy 110 will be limited to the web services layer 158 while files that are subject to one or more retention rules 114 are mishandled locally at the user device 106, the local version of the retention policy enforcement engine 108 may be configured to locally enforce the unified retention policy 110 by analyzing any locally stored message data 130(A) and/or locally stored synchronized files 140(S). Various implementations of the system 100, therefore, may be configured to enforce the unified retention policy 110 both at a web services layer 158 (e.g. retaining and/or deleting files from one or more servers corresponding to the productivity platforms 104) as well as at a local data layer 160 (e.g. retaining and/or deleting files from a hard drive and/or cache of the user device 106).

In some implementations, the local version of the retention policy enforcement engine 108 may further be configured to analyze the unsynchronized files 148 on the local storage 146 to identify individual files that are subject to one or more file retention rules 114 and, ultimately, to enforce the unified retention policy 110 with respect to even these unsynchronized files 148. For example, the information worker 152 may utilize a portable storage device such as, for example, a USB drive to move some of the hosted files 140 (or any other organization data for that matter) to the local storage 146. Furthermore, these hosted files 140 may have been labeled automatically by the system 100 and/or manually by the information worker 152 as being tax related files. Under these circumstances, the system 100 may identify one or more of the unsynchronized files 148 that are affected by a particular file retention rule 114 and then perform a corresponding action with respect to these identified files.

In some implementations, the system 100 may selectively transmit the unified retention policy 110 only to user devices 106 that correspond to the one or more file subsets 132. For example, in a scenario in which the filter parameters 120 indicate a selective activation of the “Tax Record Policy” file retention rule 114 with respect to the “Tax Group,” the system 100 may identify the user devices 106 associated with the “Tax Group” and may selectively transmit a “Tax Record Policy” file retention rule 114 to these user devices. Accordingly, the local version of the retention policy enforcement engine 108 and/or the message module 144 may receive only those file retention rules that are applicable to files stored on the particular user device 106.

Turning now to FIG. 1B, an example data flow scenario is illustrated where the system 100 selectively activates the unified retention policy 110 by causing the retention policy management service 102 to analyze data received from the productivity platforms 104 and then instruct the individual productivity platforms 104 to perform actions in accordance with the retention policy 110. It can be appreciated that the data flow scenario of FIG. 1A has much in common with the data flow scenario of FIG. 1B and, therefore, for brevity such similarities need not be discussed in detail with respect to FIG. 1B. For example, in each data flow scenario the system 100 may expose the RPMP 112 via the device 156 to enable the retention policy administrator 154 to indicate filter parameters 120 for selectively activating file retention rules 114 and/or file management labels 116 with respect to one or more subsets of files across one or more productivity platforms 104. For example, the RPMP 112 may enable an administrator to indicate filter parameters 120 to prescribe a file management label 116 to both the communication platform 104(A) and the file hosting platform 104(B) with respect to file subsets 132 that correspond to a predetermined organizational group. Furthermore, individual ones of the productivity platforms 104 such as, for example, the communication platform 104(A) and the file hosting platform 104(B) may be configured to communicate with the user device 106. For example, the communication platform 104(A) may be configured to communicate with and/or transmit the message data 130(A) to the message module(inbox) 134.

It can also be appreciated that there are several differences between these data flow scenarios. In particular, in the example dataflow scenario of FIG. 1B, individual productivity platforms 104 transmit productivity data 130 to the retention policy management service 102 and, based thereon, receive from the retention policy management service 102 instructions 162 indicating actions to perform with respect to various portions of the transmitted data. For example, the communication platform 104(A) is shown to transmit the message data 130(A) to the retention policy management service 102. As described above, the message data 130(A) may correspond to the information worker 152′s email inbox(s) 134, email outbox(s) 136, and/or archive folder(s) 138. Upon receipt of the message data 130(A), the retention policy enforcement engine 108 may analyze the message data 130(A) with respect to the filter parameters 120 to identify the file subset 132(A). Then, the retention policy enforcement engine 108 may analyze individual files of the file subset 132(A) with respect to the unified retention policy 110 to identify a plurality of files (e.g. email files and/or other files that are included in an email file as an attachment) that satisfy the condition(s) of individual file retention rules 114. Similarly, the file hosting platform 104(B) is shown to transmit the hosted data 130(B) to the retention policy management service 102, which then may analyze the hosted data 130(B) to identify another plurality of files of the file subset 132(B) that satisfy various conditions of the file retention rules 114.

Upon identifying one or more sets of files that are subject to various ones of the file retention rules 114, the retention policy management service 102 may then transmit instructions 162 to the individual productivity platforms 104 to cause actions corresponding to the various ones of the file retention rules 114 to be performed with respect to the one or more sets of files. For example, the retention policy enforcement engine 108 may analyze the message data 130(A) to determine the file subset 132(A) and, ultimately, to identify a plurality of emails that are included within the file subset 132(A) and that have reached or exceeded a predefined file purge age. The retention policy enforcement engine 108 may further analyze the hosted data 130(B) to determine the file subset 132(B) and, ultimately, to identify a plurality of word processing documents and/or spreadsheet workbooks that are included within the file subset 132(B) and that have also reached or exceeded the predefined file purge age. Then, the retention policy enforcement engine 108 may transmit an instruction 162(A) to cause the communication platform 104(A) to purge the plurality of emails from the message data 130(A) while also transmitting an instruction 162(B) to cause the file hosting platform 104(B) to purge the plurality of word processing documents and/or spreadsheet workbooks from the hosted data 130(B).

In some implementations, individual productivity platforms 104 may be configured to transmit a subset of files, from their corresponding data, to the retention policy management service 102 based on certain events occurring with respect to individual ones of the subset of files. For example, upon the information worker 152 attempting to delete a particular message from her inbox 134, the communication platform 104(A) may be configured to transmit this particular message to the retention policy management service 102 and then wait to receive an instruction 162(A) before deleting the particular message. Then, in the event that the instruction 162(A) indicates that the information worker 152 is permitted to delete this particular message based on the unified retention policy 110, the communication platform 104(A) may permanently delete the particular message. On the other hand, in the event that the instruction 162(A) indicates that the information worker 152 is not permitted to delete this particular message, the communication platform 104(A) may retain the particular message and/or transmit the particular message to an archive.

In some implementations, the system 100 may further be configured so that individual productivity platforms 104 relay instructions 162 to the local version of the retention policy enforcement engine 108 at the user device 106 to enforce the unified retention policy 110 at the local data layer 160. For example, the instruction 162(A) may be transmitted to the user device 106 to cause the message module 144 to delete messages that have reached or exceeded a predefined file purge age and/or retention age threshold. In various implementations, the local version of the retention policy enforcement engine 108 may be configured to scan the local storage 146 to identify locally stored copies of files corresponding to a particular instruction 162. For example, consider a scenario where the information worker 152 has used a local email client to manually drag an email message from the message module 144 to a non-synchronized folder contained within the local storage 146. Further suppose that the message module 144 lacks the capabilities to identify and/or perform actions with respect to the email message that has been copied to the local storage 146. Under these circumstances, the retention policy enforcement engine 108 may be configured to scan the local storage 146 to locate this email message in the local storage 146 and, ultimately, to cause the email message to be purged from the local storage 146 upon the message having reached or exceeded the predefined file purge age.

Turning now to FIG. 1C, an example data flow scenario is illustrated where the system 100 deploys the file labeling engine 126 to provide the file management labels 116 to the productivity platforms 104 and/or the user device 106. In some implementations, the file management labels 116 include one or more labels that may be displayed at the user device 106 to enable the information worker 152 to manually tag individual files of the productivity data 130 with individual ones of the one or more labels. For example, the information worker 152 may review email messages within the message data 130(A) and manually apply a “Tax Record” label to an individual email message. In some implementations, the information worker 152 may access the productivity platforms 104 via the web module 150 and manually tag individual files with the labels via a web portal user interface. That is, the information worker 152 may manually tag the individual files while accessing an online version of a productivity platform 104. In some implementations, the file management labels 116 may be transmitted to the user device 106 to enable the information worker 152 to manually tag individual files with the labels locally at the user device 106. For example, the message module 144 may be an email client (e.g. MICROSOFT OUTLOOK) that, upon receipt of the file management labels 116, enables the information worker 152 to locally label individual email messages. In some implementations, the message module 144 may be configured to synchronize with the productivity platform 104 to cause labels placed on individual files via the message module 144 to also be placed on those files within the productivity data 130 as stored at the productivity platform 104. For example, based on these techniques, a file labeled as “Tax Record” within the message module 144 would eventually be synchronized with the productivity platform 104 such that it is also file labeled as “Tax Record” when viewed via a web-based version of the productivity platform 104.

In some implementations, the file management labels 116 include a plurality of sets of labels and the RPMP 112 is configured to enable the retention policy administrator 154 to selectively cause individual sets of labels to be displayed on an individual user basis and/or a user group basis. For example, in various implementations, the RPMP 112 may enable the retention policy administrator 154 to define a set of accounting related labels as well as a set of legal related labels and, ultimately, to selectively activate the set of accounting related labels with respect to members of an accounting team and also to selectively activate the set of legal related labels with respect to members of a legal team. For example, the selective activation may cause the set of accounting related labels to be displayed to members of the accounting team and also cause the set of legal related labels to be displayed to the members of the legal team. Accordingly, the retention policy administrator 154 can prevent the information worker 152 from having to sift through large numbers of file management labels which are irrelevant to her work responsibilities while still providing her access to those labels which are potentially relevant to files she is performing work with so that she may manually tag individual files as appropriate.

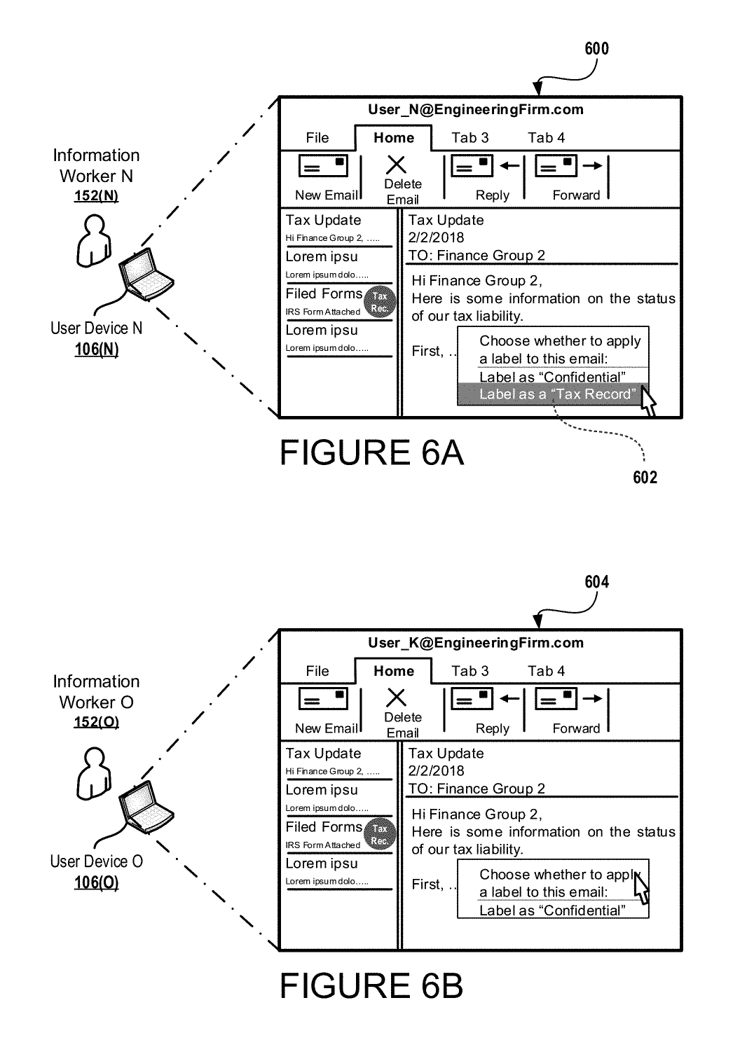

In some implementations, the system 100 is configured to analyze the productivity data 130 with respect to smart label rules 124 to automatically label individual files without manual input from the information worker 152. For example, the file labeling engine 126 may be configured to receive the productivity data 130 and analyze individual files within the productivity data 130 with respect to the smart label rules 124 to determine whether any individual files satisfy one or more of the smart label rules 124. Exemplary smart label rules 124 include, but are not limited to, rules that search for individual files that contain one or more predefined types of sensitive information, positively match a user-defined search query, correspond to a predefined document fingerprint, or any combination thereof. Then, once the system 100 has identified individual files that satisfy one or more smart label rules 124, the system 100 may automatically apply corresponding labels to the individual files to define smart labeled files 170 that may then be transmitted to the productivity platforms 104. In some implementations, a particular file that has been labeled as a smart labeled file may be displayed to the information worker 152 along with an indication that this particular file has been automatically labeled according to one or more of the smart label rules 124. For example, suppose that the productivity data 130 that is sent to the file labeling engine 126 contains an individual email that includes an IRS tax form as an attachment. Further suppose that an individual smart label rule 124 has been designed by the retention policy administrator 154 to identify IRS tax forms and to label these forms (and/or communications containing these forms such as the email of the present scenario) with a “Tax Record” label. Under these circumstances, the system 100 may identify that this individual email includes the IRS tax form and, based thereon, the system may apply the “Tax Record” label to this individual email. In some implementations, individual files that are manually labeled or automatically label based on one or more smart label rules 124 may be displayed to the user along with an indication that such files have been labeled. For example, with particular reference to FIGS. 6A-6B, in each of GUI 600 and GUI 604 the third email down from the top is displayed to the user as being labeled with the “Tax Record” file management label.

In some implementations, the system 100 may be configured to analyze data corresponding to a delete request 172 to determine whether a particular file that the information worker 152 is attempting to delete satisfies one or more conditions associated with a particular file retention rule 114. For example, upon the user attempting to delete a particular email, the system 100 may analyze this particular email to identify that it satisfies the conditions associated with a “Tax Record” file retention rule. Then, based on having identified the particular email as a tax record, the system may prevent this file from being modified and/or deleted according to the unified retention policy 110. For example, the unified retention policy 110 may indicate to the information worker 152 that tax records are to be retained until they reach a retention age threshold or at least be retained for a file retention period. In some implementations, a particular file retention rule may indicate that individual files that satisfy certain conditions are restricted from being modified. For example, the “Tax Record” file retention rule may define one or more conditions under which individual files must be retained and/or deleted and/or restricted from being modified. In some implementations, a particular file retention rule may also have a particular file management label associated therewith to cause the system 100 to automatically label individual files with the particular file management label based on a determination that the particular file retention rule applies to the individual files. For example, the unified retention policy 110 may associate the “Tax Record” file retention rule with a “Tax Record” file management label to cause the system 100 to automatically label individual files that satisfy the “Tax Record” rule as being tax records. In some implementations, the unified retention policy 110 may further indicate that individual files are restricted from being modified once they are labeled as tax records. Under these circumstances, upon receiving the delete request 172 indicating that the information worker 152 has attempted to delete a particular file that is labeled as a tax record, the system 100 may prevent the particular file from being deleted (or modified for that matter) until the particular file reaches its corresponding predefined retention age threshold at which time the system 100 may automatically purge this particular file from the system 100 storage.

In some implementations, the system 100 may be configured to enable the information worker 152 to delete the particular file with respect to her productivity platform account but also to transfer the particular file, as user deleted data 174, to a data retention archive 176 in order to abide by the unified retention policy 110. Based on these techniques, the system 100 may give to the information worker 152 an appearance that a particular data file has been deleted even though that file has been archived for retention purposes. It can be appreciated that these techniques will benefit the information worker 152 by allowing her to organize (and/or decrease an amount of file-based clutter of) her productivity data 130. These techniques may further benefit the information worker when productivity platforms 104 have corresponding storage allotments assigned thereto for individual user accounts. For example, the information worker 152 may be assigned an email account that is provisioned with a limited storage allotment of, for example, a predefined number of megabytes. By permitting the information worker 152 to delete particular files from her account even when those files are subject to the unified retention policy 110, the system 100 mitigates difficulties associated with the information worker 152 running out of available storage within her storage allotment without impacting an organization's ability to abide by the unified retention policy 110.

To further illustrate these concepts, consider a scenario where the information worker 152 is allotted twenty-five megabytes (MB) of storage in an email account corresponding to the communication platform 104(A). Further consider that the information worker 152 receives a large email file that has been labeled as a tax record that has been assigned a particular retention age threshold (e.g. seven years) and that the information worker 152 attempts to delete this large email file from her email account due to its large size. Under these circumstances, the system 100 may receive a request to delete this email file from the information worker's user account and, based thereon, cause the large email file to be removed from her email account's twenty-five MB storage allotment. Furthermore, based on a determination that the email has yet to reach the retention age threshold, the system may cause the email file to be archived in the data retention archive 176 at least until the email file reaches the predefined retention age threshold. Then, the system may later determine that the email file has reached the predefined retention age threshold and as a result purge the email file from the data retention archive 176.

FIG. 2 illustrates an example data flow scenario of the system 100 deploying filter parameters 120 to selectively activate various unified retention policies 110 with respect to user selected individuals and/or user selected predefined organizational groups. As illustrated, the retention policy administrator 154 has defined filter parameters 120 and has further caused the device 156 to transmit those filter parameters 120 to the retention policy management service 102. In various implementations, the account data 118 at least partially defines logical groupings of individual user accounts 202 (user accounts C through H as labeled) such as, for example, by indicating an organizational hierarchy 204. As illustrated, the account data 118 defines two finance groups, each of which report to a Chief Finance Officer and also two legal groups each of which report to a Chief Legal Officer. Furthermore, the account data 118 defines a reporting relationship between a Chief Executive Officer and each of the Chief Legal Officer and the Chief Finance Officer. Furthermore, the account data 118 may also define an ad hoc group that is not formally a part of the organizational hierarchy 204 but rather is created for a specific purpose only.

In some implementations, the RPMP 112 may enable the retention policy administrator 154 to indicate filter parameters 120 that selectively activate individual versions of the unified retention policy 110 with respect to individual user accounts 202 and/or individual predefined organizational groups. In the illustrated example, the retention policy administrator 154 has created a “Tax Record” retention policy (RP) 110(A) and indicated filter parameters 120 to selectively activate the “Tax Record” RP 110(A) with respect to a “Tax Group.” Accordingly, the “Tax Record” RP 110(A) has been assigned to each user account that is included within the “Tax Group” to cause file retention rules 114 included within the “Tax Record” RP 110(A) to be deployed with respect to these user accounts. For example, suppose that the “Tax Record” RP 110(A) includes a smart label rule 124 that is designed to identify files having one or more characteristics associated with IRS tax forms and, based thereon, to automatically apply a “Tax Record” file management label 116 to these files. In some instances, a “Tax Record” file management label 116 may be associated with a particular file retention rule 114 such as, for example, a rule that causes the system 100 to forcibly retain files labeled as a “Tax Record” for at least a file retention period, and then causes the system 100 to automatically delete such files upon these files having reached a file purge age. Accordingly, it can be appreciated that in some instances a single file management label 116 may instruct the system 100 to both retain a particular file for a first period of time and then to automatically delete the particular file after the first period of time and/or a second period of time.

In some implementations, the RPMP 112 may enable the retention policy administrator 154 to indicate filter parameters 120 that selectively exclude individual user accounts 202 and/or predefined organizational groups from a particular version of a retention policy. For example, as illustrated, the filter parameters 120 cause the system 100 to selectively activate an “External Audit” RP 110(B) with respect to an “Accounting Group.” Additionally, the filter parameters 120 indicate an RP exclusion 110(EX) that causes the system 100 to selectively exclude user account M from the selective activation of the “External Audit” RP 110(B). Stated alternatively, in some implementations, the RPMP 112 may enable the retention policy administrator 154 to indicate filter parameters 120 to selectively activate a retention policy with respect to a predefined organizational group with the exception of one or more user selected members of that predefined organizational group. For example, if the predefined organizational group includes 26 members such as, for example, members “A-Z,” the retention policy administrator may indicate a first filter parameter 120 to selectively activate the retention policy with respect to the entire predefined organizational group and second filter parameter 120 to selectively exclude member “A.” Under these circumstances, the retention policy may be selectively activated with respect to 25 individuals, i.e. members “B-Z.”

In some implementations, the RPMP 112 may enable the retention policy administrator 154 to indicate filter parameters 120 that selectively activate a retention policy with respect to one or more user accounts that are associated with but not included within a predefined organizational group that the retention policy has been selectively activated with respect to. As illustrated, the retention policy administrator 154 has indicated filter parameters 120 to selectively activate each of the “Tax Record” RP 110(A) and the “External Audit” RP 110(B) with respect to the Chief Finance Officer notwithstanding the Chief Finance Officer not being included within either the “Tax Group” that the “Tax Record” RP 110(A) was activated with respect to or the “Accounting Group” that the “External Audit” RP 110(B) was activated with respect to. In some implementations, the filter parameters 120 may cause the system 100 to identify a relationship between a predefined organizational group and one or more other groups and/or user accounts defined by the account data 116. For example, as illustrated, each of the “Accounting Group” and the “Tax Group” report up to the Chief Finance Officer and, accordingly, the filter parameters 120 cause the Chief Finance Officer's user account to have all of her reporting group's retention policies selectively activated with respect to her account as well.

In some implementations, the filter parameters 120 may cause the system 100 to identify a relationship between an individual user account and one or more associated predefined organizational groups to cause a retention policy to be selectively activated with respect to an individual user account as well as predefined organizational groups associated therewith. For example, as illustrated, the retention policy administrator 154 has indicated filter parameters 120 to selectively activate a “Legal” RP 110(D) with respect to a user account of the Chief Legal Officer. Furthermore, the retention policy administrator 154 has further indicated filter parameters 120 to selectively activate the “Legal” RP 110(D) with respect to the “Risk Control Group” and the “Contracts Group” based on these groups' relationships to the Chief Legal Officer. For example, the organizational hierarchy 204 may indicate a reporting relationship between these two groups and the Chief Legal Officer.

In some implementations, the RPMP 112 may enable the retention policy administrator 154 to indicate filter parameters 120 that selectively activate a retention policy on an individual user account basis. For example, as illustrated, the retention policy administrator has generated an “Executive” RP 110(C) and test selectively activated this policy with respect to the user accounts associated with the Chief Executive Officer, the Chief Legal Officer, and the Chief Finance Officer.

In some implementations, the RPMP 112 is configured to enable the retention policy administrator 154 to define organizational groups that are not included within the account data 116. For example, a particular project may arise such as a trademark lawsuit that the organization is a party to and one or more individuals from one or more different predefined organizational groups may be assigned to work on the trademark lawsuit. Accordingly, the retention policy administrator 154 may create an ad hoc “Trademark Litigation Group” and may assign an “Ad Hoc Group” RP 110(E) to this group. Accordingly, in addition to being able to selectively activate retention policies with respect to predefined organizational groups such as, for example, groups associated with the organizational hierarchy 204, the retention policy administrator may also be able to define organizational groups independent of an organizational hierarchy 204.

FIGS. 3A-3G illustrate aspects of a graphical user interface (GUI) corresponding to the RPMP 112 that can be displayed on a device 156 to enable a user to generate and selectively activate file retention rules 114 across an organization. It will be appreciated that FIGS. 3A-3G may correspond to a logical flow of a sequence of GUIs that enable the retention policy administrator 154 to enter a name and/or description for a new file retention rule 114, define settings for the new file retention rule 114, and/or to selectively activate the new file retention rule 114 with respect to various locations (e.g. user selected productivity platforms and/or predetermined organizational groups and/or individual user accounts). It can be appreciated that the particular sequence of GUIs illustrated herein is included for explanatory purposes only and is not to be construed as a limitation.

Turning now to FIG. 3A, aspects are illustrated of a GUI 300 corresponding to the RPMP 112 that can be displayed on the device 156 to enable the retention policy administrator 154 to select a name for the new file retention rule 116 and/or to enter an optional description of the new file retention rule 116. In the illustrated scenario, the retention policy administrator 154 has named the new file retention rule 114 “Tax Record Policy” but has not entered a description for the rule.

Turning now to FIG. 3B, aspects are illustrated of a GUI 302 corresponding to the RPMP 112 that can be displayed on the device 156 to enable the retention policy administrator 154 to define settings for the new “Tax Record Policy” file retention rule (FRR) 114 based on one or more predefined conditions that are built into the system 100 and/or by defining a custom search query. In the illustrated scenario, the retention policy administrator 154 is defining the “Tax Record Policy” FRR 116 to perform one or more specified actions with respect to individual files that satisfy one or more specified conditions that are indicative of these files being tax records. For example, as illustrated, the retention policy administrator 154 has indicated that she would like to apply this rule to documents that are sent within a predefined date range (i.e. 12/1/2016-1/15/2017) and are sent by members of a predefined accounting team. Exemplary predefined conditions include, but are not limited to, a date that a file was transmitted, a date that a file was received, a date that a file was created, a date that a file was modified, a sender email address, a recipient email address, a text string of a subject line of an email, or any other condition or combination of conditions deemed relevant by the retention policy administrator 154.

It can be appreciated that members of the accounting team might send and/or receive emails within this predefined date range that are wholly unrelated to taxes. For example, the information worker 152 may have been assigned to assist an organization in preparing tax documents but may also have various work responsibilities that are unrelated to preparing tax documents. Furthermore, the information worker 152 may use her organization assigned email for at least some personal reasons. Accordingly, there may be many files and/or emails sent during this predefined date range that should not be labeled as or otherwise determined to be a “Tax Record.” Under these circumstances, it can be appreciated that simply treating any email sent during this predefined date range by any member of the accounting team as a “Tax Record” may be over-inclusive and cause numerous non-tax related files to be treated as a “Tax Record.” With respect to this concern, the retention policy administrator 154 has defined a search query to be performed against individual files to limit the application of the “Tax Record” label to files containing at least one of a predefined set of terms. In particular, as illustrated, only files that contain at least one of the terms “Tax*”, or “Form 1099*”, etc. will be determined by the system 100 to be a “Tax Record” and/or automatically labeled as a “Tax Record” by the file labeling engine 126. Although any suitable search query language may be deployed to define file retention rules 114 and/or smart label rules 124, exemplary search query languages include the Keyword Query Language (KQL) and the FAST Query Language (FQL) which are included in MICROSOFT SHAREPOINT.

In some implementations, the GUI 302 may prompt the retention policy administrator 154 to indicate whether she would like to retain content by defining a file retention period during which the file will be forcibly retained (e.g. requests to delete the file are to be ineffective) and/or a file purge age at which files are to be automatically deleted. As illustrated, the retention policy administrator 154 has selected user interface element (UIE) 304 such as a radio button to define a file retention period to the “Tax Record Policy” file retention rule 116. Here, the retention policy administrator 154 has set the file retention period to seven years. As further illustrated, the retention policy administrator 154 has selected another UIE 306 to define a file purge age for the “Tax Record Policy” file retention rule 116. Here, the retention policy administrator 154 has set the file purge age to nine years. By defining the file retention period of seven years and the file purge age of nine years, the retention policy administrator 154 is able to simultaneously prevent files that have been labeled as (or otherwise determined to be) a “Tax Record” from being deleted and/or modified prior to that file reaching the file retention period while also instructing the system 100 to automatically delete such files once they reach the file purge age. It can be appreciated that the GUI 302 may also enable the retention policy administrator 154 to generate a rule to cause the system 100 to automatically delete content upon reaching a file purge age without preventing the information worker 152 from deleting and/or modifying such content prior to the content reaching that file purge age, e.g. by selecting UIE 306 but not UIE 304. Furthermore, the GUI 302 may also enable the retention policy administrator 154 to generate a rule to cause the system 100 to prevent content from being deleted until it reaches a certain age without causing the system to automatically delete such content upon reaching that certain age, e.g. by selecting UIE 304 but not UIE 306.

Turning now to FIG. 3C, aspects are illustrated of a GUI 308 corresponding to the RPMP 112 that can be displayed on the device 156 to enable the retention policy administrator 154 to define settings for the “Tax Record Policy” FRR 114 that corresponds to files containing one or more sensitive content types. In the illustrated scenario, the retention policy administrator 154 has selected a UIE 310 (e.g. a radio button) that enables her to associate sensitive content types with the “Tax Record Policy” FRR 114. In the illustrated scenario, the retention policy administrator 154 has selected three sensitive content types to associate with the new “Tax Record Policy” file retention rule 114. In some implementations, the retention policy administrator 154 may positively associate sensitive content types with a new file retention rule to cause actions defined for the new file retention rule to be performed with respect to documents that contain the selected sensitive content types. For example, according to the illustrated scenario, the system 100 may analyze the productivity data 130 to identify individual files that contain one or more of an Employer Identification Number (EIN), a U.S. Individual Taxpayer Identification Number (ITIN), or a U.S. Social Security Number (SSN). In some implementations, the retention policy administrator 154 may negatively associate sensitive content types with a new file retention rule to prevent documents that contain the selected sensitive content types from being processed according to the rule. For example, according to the illustrated scenario, the system 100 may analyze the productivity data 130 to identify individual files that contain a U.S. Driver's License Number to prevent these documents from being labeled or otherwise treated as a “Tax Record.” Exemplary sensitive content types include, but are not limited to, bank routing numbers, bank account numbers, driver's license numbers, medical account numbers, passport numbers, tax file numbers, health service numbers, personal health identification numbers (PHIN), resident identity card numbers, and/or credit card numbers.

In various implementations, the system 100 may be configured to identify sensitive content types based on predefined patterns that can be identified based on a regular expression (REGEX) and/or function. For example, the system 100 may analyze numbers that are identified within files to determine whether these numbers correspond to a REGEX indicating that it is a credit card number. The system 100 may further be configured to identify and weigh corroborative evidence such as keywords and checksums to identify and/or validate sensitive content types. In various implementations, the system 100 may be configured to determine a confidence level associated with a finding of a sensitive content type and apply corresponding labels based on the confidence level reaching or exceeding the confidence threshold. For example, suppose that a smart label rule 124 has been defined to instruct the system 100 to label individual files as tax records in response to identifying an employer identification number with at least a 70% level of confidence.

In the illustrated scenario, the GUI 308 further includes a retention age threshold UIE 312 that can be displayed on the device 156 to enable the retention policy administrator 154 to define a retention age threshold. In some implementations, a retention age threshold may correspond to a single user-defined age below which a file will be forcibly retained by the system 100 and at which a file will be automatically deleted by the system 100. For example, as illustrated, the retention policy administrator has defined the retention age threshold of seven years to cause the system 100 to forcibly retain individual files that are younger than seven years old (as measured from the date of creation and/or a date of last modification) and to further cause the system 100 to automatically delete individual files once they reach seven years of age. Stated alternatively, in some implementations the retention policy administrator 154 is enabled to simultaneously define a file retention period and a file purge age with a single number, i.e. the retention age threshold.

Turning now to FIG. 3D, aspects are illustrated of a GUI 314 corresponding to the RPMP 112 that can be displayed on the device 156 to enable the retention policy administrator 154 to define settings for the “Tax Record Policy” FRR 114 that corresponds to the files matching a predefined document fingerprint. The GUI 314 is similar to the GUI 308 with the exception that the retention policy administrator 154 has selected a document fingerprint UIE 316 that enables her to associate one or more document “Fingerprints” with the new “Tax Record” rule. In the illustrated scenario, the retention policy administrator 154 has selected an “IRS Tax Form” document fingerprint. As used herein, the term “document fingerprint” refers generally to one or more predefined characteristics that correspond to a specific type and/or class of document. For example, it may be determined that a file having a header that contains the word “FORM W” followed by a number indicates a high likelihood of that file being an IRS tax form. As another example, it may further be determined that files containing the phrase “Privacy Act Notice” within some specified distance from the phrase “of the Internal Revenue Code” further indicates a high likelihood of that file being an IRS tax form. Accordingly, a document fingerprint may be defined within the new file retention rule 116 to cause any individual file having these two predefined characteristics to be determined to match the “IRS Tax Form” document fingerprint and, ultimately, to be designated as an IRS tax form, e.g. by being tagged with a “Tax Record” file management label.

Turning now to FIG. 3E, aspects are illustrated of a GUI 318 corresponding to the RPMP 112 to enable the retention policy administrator 154 to activate the “Tax Record Policy” FRR 114 across all locations of a productivity suite or to selectively activate the “Tax Record Policy” FRR 114 with respect to user-specified locations based on the filter parameters 120. As illustrated, the retention policy administrator 154 has selected a UIE 320 that indicates that she would like to define filter parameters 120 to selectively activate the “Tax Record Policy” FRR 114 to a subset of files.

Turning now to FIG. 3F, aspects are illustrated of a GUI 322 corresponding to the RPMP 112 to enable the retention policy administrator 154 to indicate filter parameters 120 to selectively activate the “Tax Record Policy” FRR 114 to user selected productivity platforms, user selected organizational groups, and/or user selected user accounts. In various implementations, the GUI 322 may include one or more UIEs to enable the retention policy administrator 154 to selectively activate the “Tax Record Policy” FRR 114 across an entire productivity platform and/or to user accounts and/or groups of user accounts to include or exclude from selective activation of the “Tax Record Policy” FRR 114. For example, as illustrated, the GUI 322 includes a communication platform UIE 324 to enable the retention policy administrator to activate the “Tax Record Policy” FRR 114 with respect to the communication platform 104(A). In the illustrated scenario, the retention policy administrator 154 has selectively activated the “Tax Record Policy” FRR 114 with respect to the communication platform 104(A) as well as another productivity platform associated with sharing sites. Furthermore, the retention policy administrator 154 has selectively deactivated the “Tax Record Policy” FRR 114 with respect to the file hosting platform 104(B). In various implementations, the GUI 322 may further include one or more UIEs to enable the retention policy administrator 154 to indicate specific user accounts corresponding to individual productivity platforms to selectively include or exclude from activation of the “Tax Record Policy” FRR 114. For example, the GUI 322 may include an “Exclude mailboxes” UIE 326 to enable the retention policy administrator to enter filter parameters 120 that selectively excludes one or more specific communication platform accounts from activation of the file retention rule 114.

In some implementations, the GUI 322 may include one or more UIEs to enable the retention policy administrator to indicate filter parameters 120 to selectively activate the “Tax Record Policy” FRR 114 to specific organizational groups and/or individual user accounts. For example, the GUI 322 may include the UIE 328 to enable selection of one or more predefined organizational groups such as, for example, the groups described with relation to FIG. 2 as corresponding to the organizational hierarchy 204 and/or the ad hoc group created by the retention policy administrator 154. In various implementations, selection of the UIE 328 may trigger GUI 330 to be displayed as shown in FIG. 3G.

Turning now to FIG. 3G, aspects are illustrated of a GUI 330 to enable the retention policy administrator 154 to indicate filter parameters 120 to selectively activate the “Tax Record Policy” FRR 114 to one or more predefined organizational groups, one or more ad hoc groups that are defined within the RPMP 112, and/or one or more individual user accounts. In the illustrated scenario, the retention policy administrator 154 has indicated filter parameters 120 to activate the “Tax Record Policy” FRR 114 with respect to “Finance Group 2” of the organizational hierarchy 204, i.e. the “Tax Group.” In some implementations, the GUI 330 includes one or more UIEs to enable selective exclusion of one or more specific user accounts. For example, the GUI 330 may enable generation of the RP Exclusion 110(EX) as described in relation to FIG. 2.

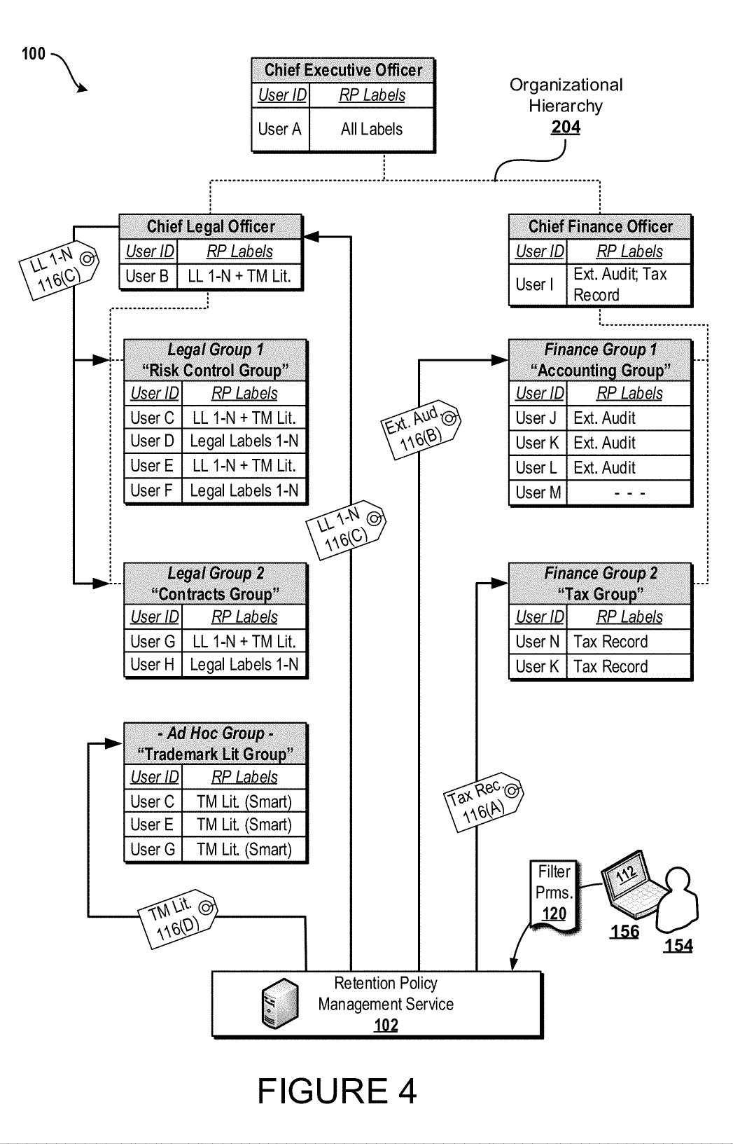

FIG. 4 illustrates an example data flow scenario of the system 100 deploying filter parameters 120 to selectively activate various file management labels 116 with respect to user selected individuals and user selected predefined organizational groups. As illustrated, the retention policy administrator 154 has defined filter parameters 120 and has further caused the device 156 to transmit those filter parameters 120 to the retention policy management service 102. It can be appreciated that the data flow scenario of FIG. 4 has much in common with the data flow scenario of FIG. 2 and, therefore, for brevity such similarities need not be discussed in detail with respect to FIG. 4. For example, in each data flow scenario the system 100 may utilize filter parameters 120 to selectively activate one or more aspects of a unified retention policy 110. The main distinction between FIG. 4 and FIG. 2 is that in FIG. 4, the filter parameters 120 cause the system 100 to selectively activate individual file management labels 116 whereas in FIG. 2 the filter parameters 120 cause the system 100 to selectively activate individual versions of a unified retention policy 110 and/or individual file retention rules thereof. It can be appreciated that any filter parameters 120 discussed with respect to FIG. 2 for selectively activating the individual versions of the unified retention policy 110 may also be used to selectively activate individual file management labels 116.

In some implementations, the RPMP 112 may enable the retention policy administrator 154 to selectively activate individual file management labels 116 of the unified retention policy 110 with respect to individual user accounts 202 and/or individual predefined organizational groups. In the illustrated example, the retention policy administrator 154 has created a “Tax Record” file management label (FML) 116(A) and has indicated filter parameters 120 to selectively activate the “Tax Record” FML 116(A) with respect to the “Tax Group.”

In some implementations, the RPMP 112 may enable the retention policy administrator 154 to indicate filter parameters 120 that selectively exclude individual user accounts 202 and/or predefined organizational groups from a particular file management label 116. For example, the RPMP 112 may enable the retention policy administrator 154 to indicate filter parameters 120 to selectively activate a file management label 116 with respect to a predefined organizational group with the exception of one or more user selected members of that predefined organizational group. For example, as illustrated, the retention policy administrator 154 has created an “External Audit” FML 116(B) label and has indicated filter parameters 120 to selectively activate this file management label with respect to members of the “Accounting Group” with the exception of user M.

In some implementations, the RPMP 112 may enable the retention policy administrator 154 to indicate filter parameters 120 that selectively activate a file management label 116 with respect to one or more user accounts that are associated with a user account and/or predefined organizational group of user accounts for which the retention policy administrator 154 has indicated a filter parameter 120. For example, as illustrated, the retention policy administrator 154 has created a plurality of legal file management labels 116(C) and has indicated filter parameters 120 to selectively activate these file management labels with respect to the Chief Legal Officer and furthermore to members of the predefined organizational groups that are associated with the Chief Legal Officer, e.g. via the organizational hierarchy 204.

In some implementations, the RPMP 112 is configured to enable the retention policy administrator 154 to define organizational groups that are not included within the account data 116. For example, as illustrated, the retention policy administrator has created a “TM Litigation” FML 116(D) and has selectively activated this label with respect to the “Trademark Litigation Group.”

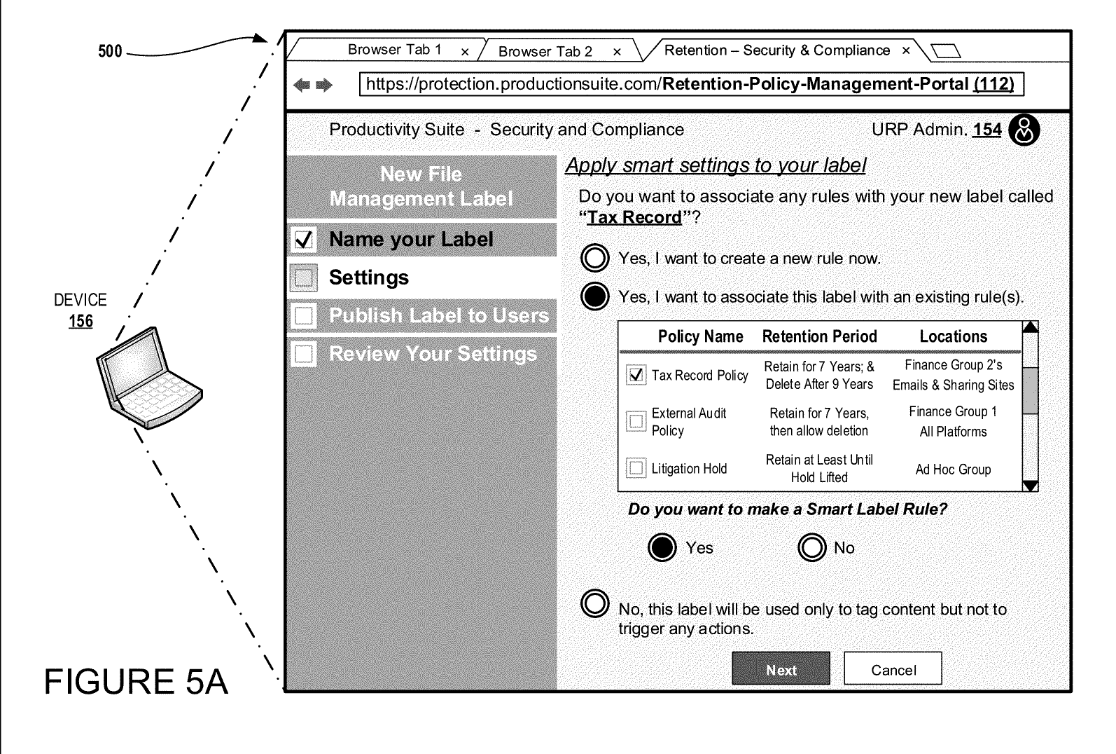

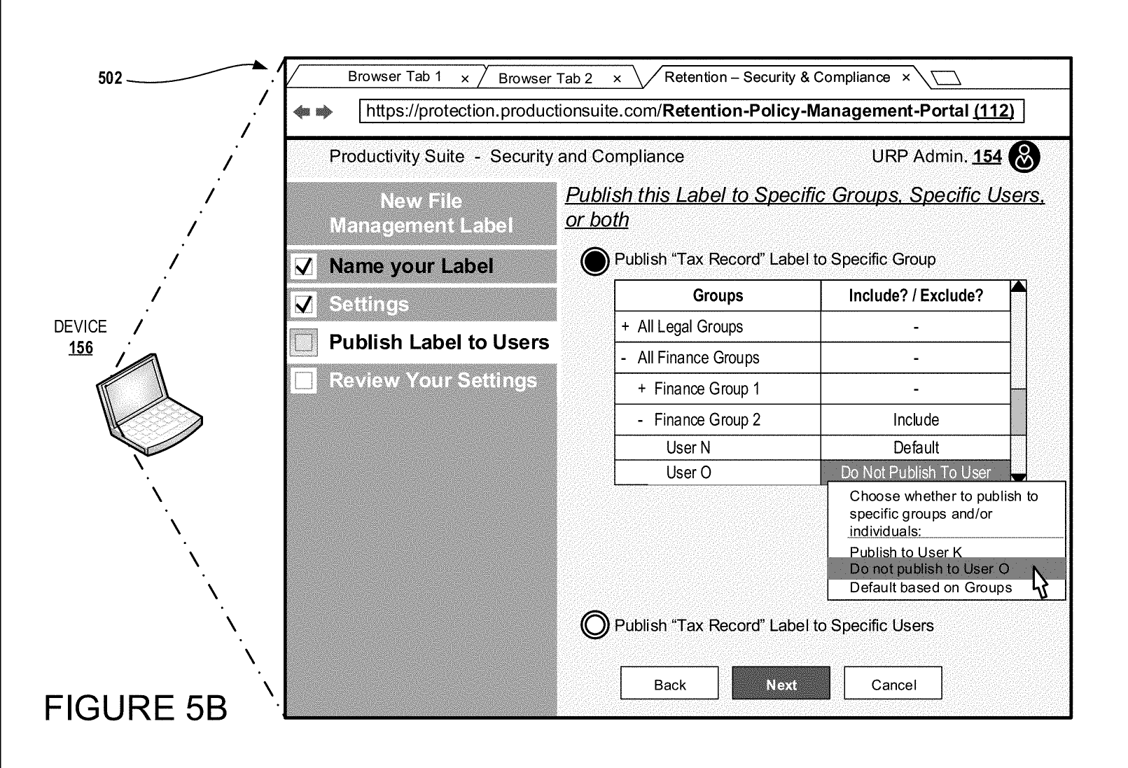

FIGS. 5A-5B illustrate aspects of a GUI 500 corresponding to the RPMP 112 that can be displayed on a device 156 to enable a user to generate and selectively activate file management labels across an organization. It will be appreciated that FIGS. 5A-5B may correspond to a logical flow of a sequence of GUIs that enable the retention policy administrator 154 to define settings for the new file management label 116 and/or to selectively activate the new file management label 116 with respect to various locations (e.g. user selected productivity platforms and/or predetermined organizational groups and/or individual user accounts). It can be appreciated that the sequence of GUIs is included for explanatory purposes only and is not to be construed as a limitation.

Turning now to FIG. 5A, aspects are illustrated of a GUI 500 corresponding to the RPMP 112 that can be displayed on the device 156 to enable the retention policy administrator 154 to define settings for the new file management label 116. In the illustrated scenario, the retention policy administrator 154 has indicated that she would like to associate this new label with an existing rule and, more specifically, the “Tax Record Policy” file retention rule 114 described in relation to FIG. 3A-3G. As illustrated, in various implementations, the GUI 500 may further include one or more UIEs to enable the retention policy administrator to indicate that she would like to create a new rule for association with the new file management label and/or to leave the new file management label unassociated with any rules such that the label will be used to manually tag content but not to trigger the system 100 to perform any actions. As further illustrated in FIG. 5A, the retention policy administrator 154 has selected a smart label rule UIE to cause the system to generate a smart label rule 124 in association with the “Tax Record” file management label. In the illustrated scenario, the retention policy administrator has checked a box next to the “Tax Record Policy” FRR discussed in relation to FIGS. 3A-3G to cause the file labeling engine to automatically label individual files with the “Tax Record” file management label based on a determination that the individual files satisfy predetermined conditions that are associated with the “Tax Record Policy” FRR. Accordingly, it can be appreciated that any conditions suitable for association with a file retention rule may also be suitable for association with a smart label rule.

Turning now to FIG. 5B, aspects are illustrated of a GUI 502 corresponding to the RPMP 112 that can be displayed on the device 156 to enable the retention policy administrator 154 to publish the new file management label 116 to specific predefined organizational groups and/or to specific user accounts. In the illustrated scenario, the retention policy administrator has indicated that she would like to publish the new label to all members of the “Finance Group 2” with the exception of “User O.” As used herein, the term “publish” may generally refer to causing a particular file management label to be displayed in association with a particular user account and/or group of user accounts.

To further illustrate these concepts, FIG. 6A illustrates aspects of a GUI 600 that can be displayed in association with a user account to which a particular file management label has been published whereas FIG. 6B illustrates aspects of a GUI 604 that can be displayed in association with a different user account that the particular file management label has not been published to. For example, with particular reference to FIG. 6A, aspects are illustrated of a GUI 600 corresponding to user account “N” to which the new “Tax Record” FML 116(A) has been published. Accordingly, the GUI 600 includes a file label UIE 602 that specifically corresponds to the new “Tax Record” FML 116(A). As illustrated, the UIE 602 is selectable by the information worker “N” 152(N) to manually label individual files with the new “Tax Record” FML 116(A). On the other hand, with particular reference to FIG. 6B, aspects are illustrated of a GUI 604 corresponding to the user account “O” to which the new “Tax Record” FML 116(A) has not been published, e.g. due to the retention policy administrator 154 expressly excluding this user account from publication of this label. Accordingly, the GUI 604 does not include the particular UIE 602 that specifically corresponds to the new “Tax Record” FML 116(A).

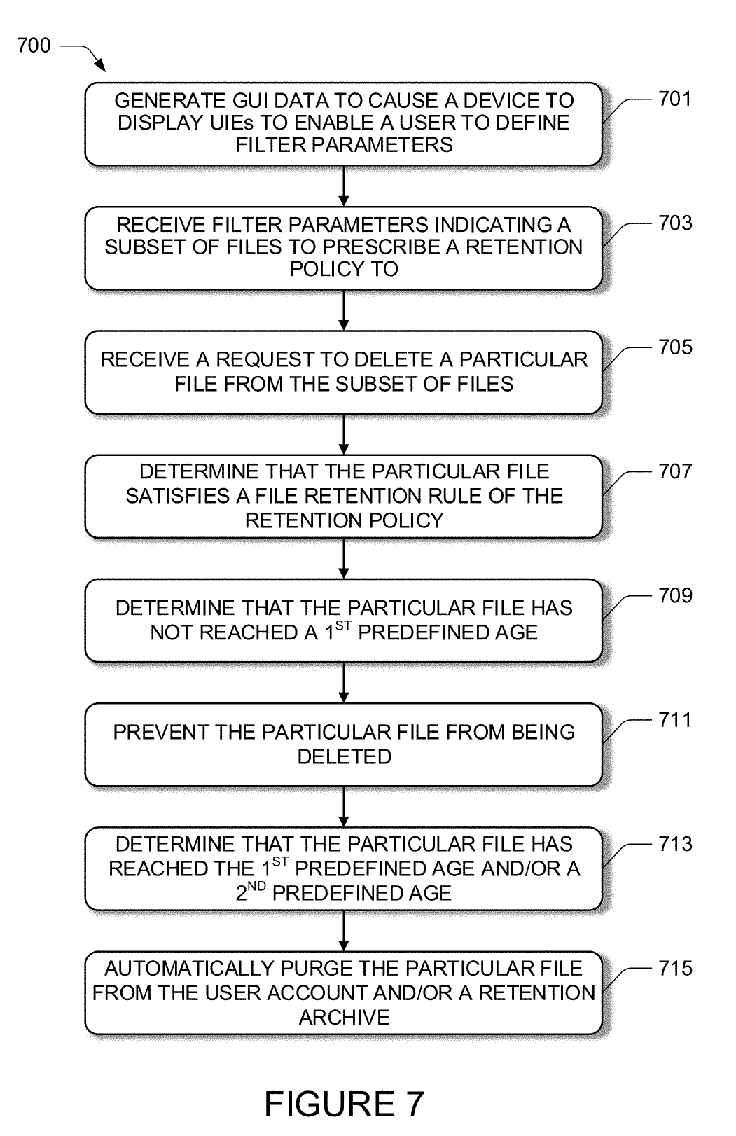

FIG. 7 is a flow diagram of an illustrative process 700 to cause a computing device 156 to display a GUI that includes a plurality of user interface elements (UIEs) to enable the user to indicate filter parameters 120 to selectively activate file retention rules and/or file management labels as described herein. The process 700 is described with reference to FIGS. 1A-6B. The process 700 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform or implement particular functions. The order in which operations are described is not intended to be construed as a limitation, and any number of the described blocks can be combined in any order and/or in parallel to implement the process. Other processes described throughout this disclosure shall be interpreted accordingly.

At block 701, a system may generate GUI data to cause a computing device 156 to display a GUI that includes a plurality of UIEs that are configured to enable a user to indicate filter parameters 120. In some implementations, the filter parameters 120 may be usable to determine a subset of files 132 from a plurality of files (e.g. files stored as message data) that correspond to at least one productivity platform. For example, filter parameters may include a parameter associated with a particular productivity platform such as, for example, the communication platform 104(A) and another parameter associated with one or more user accounts that correspond to the communication platform 104(A). Under these circumstances, the filter parameters may be usable by the system to parse a plurality of email files associated with the communication platform 104(A) to identify a subset of files associated with the one or more user accounts.

At block 703, the system may receive filter parameters 120 indicating a subset of files 132 to prescribe one or more aspects of a retention policy to. In various instances, the filter parameters 120 may be received via a retention policy management portal (RPMP) 112 that enables a retention policy administrator 154 to selectively assign various aspects of a retention policy to individual user accounts and/or predefined organizational groups of user accounts. In various instances, the filter parameters 120 may also enable the retention policy administrator 154 to selectively assign various aspects of the retention policy to various accounts or groups on an individual productivity platform basis. For example, a particular user may be assigned user credentials associated with a user account that enable this particular user to sign in to his or her user account on both a first productivity platform and a second productivity platform. Under these circumstances, the RPMP 112 may enable the retention policy administrator 154 to prescribe the retention policy to this particular user account with respect to only the first productivity platform, only the second productivity platform, or both the first productivity platform and the second productivity platform. It is worth noting that as used herein, the term “retention policy” differs from the term “unified retention policy” in the sense that a retention policy is not necessarily configured to be deployed across multiple productivity platforms. Accordingly, it can be appreciated that a “unified retention policy” is also a “retention policy,” whereas a “retention policy” is not necessarily a “unified retention policy.” Stated alternatively, unified retention policies can be considered a class or type of retention policy. In various instances, the retention policy may associate a predetermined label with a retention age threshold such that individual files that are labeled with the predetermined label are subject to the retention age threshold.

At block 705, the system may receive a request to delete a particular file from the subset of files 132 that correspond to the filter parameters 120. For example, the filter parameters 120 may indicate a subset of files 132 that correspond to a particular information worker 152 and the first productivity platform. Then, the particular information worker 152 may sign into the first productivity platform using credentials associated with her user account and, ultimately, select a particular file associated with the first productivity platform and instruct the system to delete this particular file. As a more specific, but nonlimiting example, the particular information worker may sign into an email account using her user credentials and attempt to delete a specific email message from this email account.

At block 707, the system may determine that the particular file for which the information worker 152 is requesting deletion satisfies one or more conditions of a file retention rule 114 of the retention policy. In some implementations, the system may analyze the particular file in response to the request received at block 705 and then, make a determination whether the particular file satisfies the one or more predetermined conditions. For example, the system may analyze the particular file with respect to the one or more conditions of the retention policy to determine whether any individual file retention rules apply to the particular file. In some implementations, an individual file retention rule may be designed to associate individual files with a particular file management label based on an individual file satisfying a particular set of predetermined conditions. Under these circumstances, in the event that the system makes a determination that a particular file satisfies this particular set of predetermined conditions, the system may associate the particular file management label with the particular file.

In some implementations, the system may analyze the particular file at some point in time prior to receiving the request to delete the particular file at block 705. For example, the system may periodically scan through data storage associated with the first productivity platform and/or the second productivity platform to identify and label individual files that satisfy predetermined conditions corresponding to individual file retention rules 114 and/or smart label rules 124. In some implementations, the system may rely on the information worker 152 to manually apply labels to individual files. For example, the system may periodically prompt the information worker 152 to apply labels to emails within an email account. Under these circumstances, at some point in time prior to block 705, the information worker 152 may have manually labeled the particular file with the predetermined label, e.g. the information worker 152 may have labeled the particular file with a “Tax Record” label upon initial receipt of the particular file.

At block 709, the system may make a determination that the particular file has not reached a first predefined age associated with the file retention rule of the retention policy. For example, continuing with the previous example, the particular file may be labeled with the “Tax Record” label which is associated with a predetermined retention period and/or retention age threshold of, for example, seven years. Accordingly, at block 709 the system may make a determination that the particular file was created and/or modified at less than the seven-year age retention threshold.

At block 711, based on the determination that the particular file was created and/or modified prior to the seven-year age retention threshold, the system may prevent the particular file from being deleted in accordance with the request received at block 705 to delete the particular file. In some implementations, the system may be configured to inform the information worker 152 that she is not permitted to delete the particular file in accordance with the retention policy. For example, the system may expose an informational pop-up window to inform the information worker that the particular file has been labeled as a “Tax Record” and that, therefore, the particular file must be retained and then deleted according to the predetermined retention age threshold. In some implementations, the system may be configured to provide the information worker 152 with an opportunity to de-associate the label from the particular file. For example, the information worker 152 may be enabled to reassess whether or not the particular file is in fact a “Tax Record.” Then, in the event that she makes a determination that the particular file is not a “Tax Record” she may de-label the particular file to gain the ability to then delete the particular file. In some implementations, preventing the particular file from being deleted at block 711 includes transferring the particular file from the user account to the data retention archive. For example, the particular file may be stored in the data retention archive for compliance purposes while having been removed from the user account. Accordingly, the particular file may in some instances no longer be accessible via the user account and furthermore may no longer count against a limited storage allotment corresponding to the user account.

At block 713, the system may make a determination that the particular file has reached at least one of the first predefined age and/or a second predefined age associated with the file retention rule. For example, continuing with the previous example, the particular file may be labeled with the “Tax Record” label which is associated with a predetermined file purge age of, for example, nine years. Accordingly, at block 713 the system may make a determination that the particular file was created and/or modified at least nine years ago. It can be appreciated that under circumstances in which the file retention rule has been associated with a retention age threshold, the determination at block 713 may be associated with the same predefined age associated with block 709.

Then, at block 715 the system may automatically purge the particular file from at least one storage device in accordance with the system's determination that the particular file has reached at least one of the first predefined age and/or the second predefined age associated with the file retention rule. For example, in a scenario where the particular file has been retained within the user account storage, the system may purge this user account storage of the particular file automatically, with or without informing the information worker 152 of the file deletion. Furthermore, in a scenario where the particular file has been retained within the data retention archive, the system may automatically purge the data retention archive of the particular file. In some implementations, the system may be configured to scan one or more storage devices to identify stray copies of the particular file and, ultimately, to purge even these stray copies of the particular file from storage devices such as, for example, the data retention archive, one or more servers associated with the productivity platforms, and even local storage of a client device. For example, suppose that the information worker 152 had at some point manually dragged the particular file to a desktop of her user device from a message module configured to operate on her user device. Upon dragging the particular file to the desktop, it can be appreciated that the information worker has created a stray copy of the particular file in the sense that this copy of the particular file is no longer stored in a location that is typically associated with the message module and/or productivity platform. Under these circumstances, based on the determination at block 713 that the particular file has reached the relevant predetermined age, the system may be configured to scan one or more predefined storage locations such as, for example, the local storage 136 to find and destroy any stray copies of the particular file.

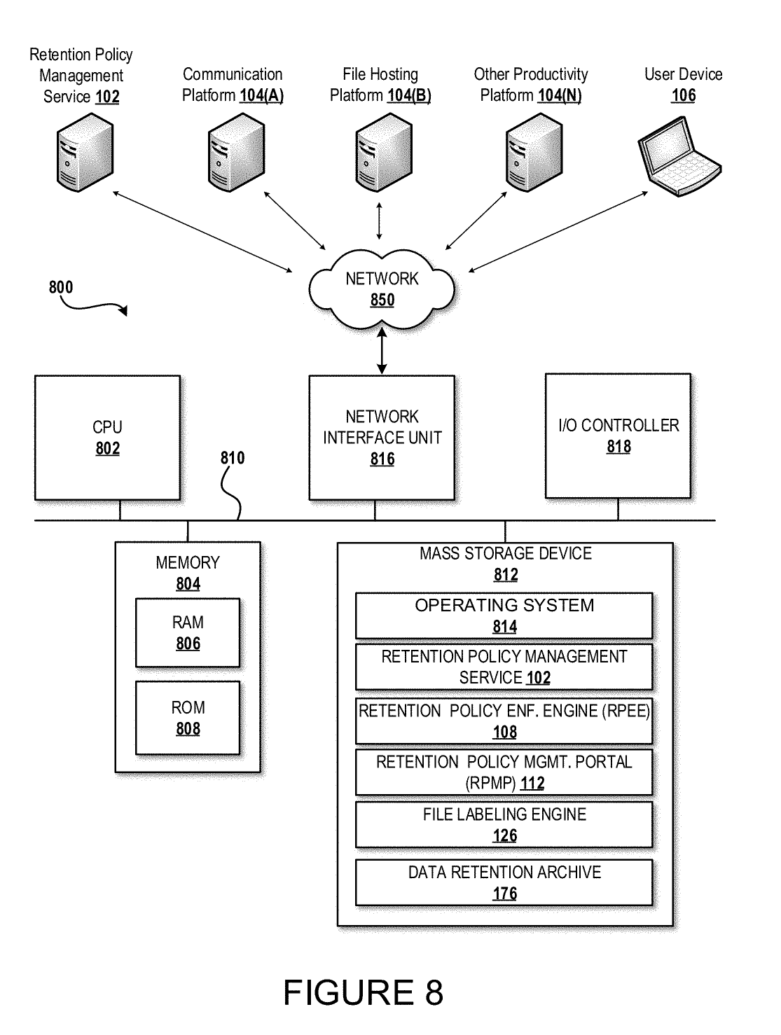

FIG. 8 shows additional details of an example computer architecture 800 for a computer capable of executing the retention policy management service 102, the communication platform 104(A), the file hosting platform 104(B), the other productivity platform 104(N), and/or any program components thereof as described herein. Thus, the computer architecture 800 illustrated in FIG. 8 illustrates an architecture for a server computer, or network of server computers, or any other types of computing devices suitable for implementing the functionality described herein. The computer architecture 800 may be utilized to execute any aspects of the software components presented herein.

The computer architecture 800 illustrated in FIG. 8 includes a central processing unit 802 (“CPU”), a system memory 804, including a random-access memory 806 (“RAM”) and a read-only memory (“ROM”) 808, and a system bus 810 that couples the memory 804 to the CPU 802. A basic input/output system containing the basic routines that help to transfer information between elements within the computer architecture 800, such as during startup, is stored in the ROM 808. The computer architecture 800 further includes a mass storage device 812 for storing an operating system 814, other data, and one or more application programs. The mass storage device 812 may further include one or more of the retention policy management service 102, the retention policy enforcement engine (RPEE) 108, the retention policy management portal (RPMP) 112, the file labeling engine 126, and/or the data retention archive 176.

The mass storage device 812 is connected to the CPU 802 through a mass storage controller (not shown) connected to the bus 810. The mass storage device 812 and its associated computer-readable media provide non-volatile storage for the computer architecture 800. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 800. For purposes of the claims, the phrase “computer storage medium,” “computer-readable storage medium” and variations thereof, does not include waves, signals, and/or other transitory and/or intangible communication media, per se.

According to various techniques, the computer architecture 800 may operate in a networked environment using logical connections to remote computers through a network 850 and/or another network (not shown). The computer architecture 800 may connect to the network 850 through a network interface unit 816 connected to the bus 810. It should be appreciated that the network interface unit 816 also may be utilized to connect to other types of networks and remote computer systems. The computer architecture 800 also may include an input/output controller 818 for receiving and processing input from a number of other devices, including a keyboard, mouse, or electronic stylus (not shown in FIG. 8). Similarly, the input/output controller 818 may provide output to a display screen, a printer, or other type of output device (also not shown in FIG. 8). It should also be appreciated that via a connection to the network 850 through a network interface unit 816, the computing architecture may enable the retention policy management service 102 to communicate with one or more of the productivity platforms 104 and/or the user device 106.

It should be appreciated that the software components described herein may, when loaded into the CPU 802 and executed, transform the CPU 802 and the overall computer architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 800 in order to store and execute the software components presented herein. It also should be appreciated that the computer architecture 800 may include other types of computing devices, including hand-held computers, embedded computer systems, personal digital assistants, and other types of computing devices known to those skilled in the art. It is also contemplated that the computer architecture 800 may not include all of the components shown in FIG. 8, may include other components that are not explicitly shown in FIG. 8, or may utilize an architecture completely different than that shown in FIG. 8.

The disclosure presented herein may be considered in view of the following clauses.

### EXAMPLE CLAUSES

The disclosure presented herein may be considered in view of the following clauses.

Example Clause A, a computer-implemented method, comprising: generating graphical user interface data to cause at least one computing device to display a graphical user interface that includes a plurality of user interface elements that are configured to enable a user to indicate filter parameters for determining, from a plurality of files that correspond to at least one productivity platform, a subset of files for selective activation of a file management label, wherein the file management label is associated with both a file retention period and a file purge age; receiving, from the at least one computing device, selection data that is generated based on activation of at least some of the plurality of user interface elements to indicate the filter parameters; and selectively activating, based on the selection data, the file management label with respect to the subset of files by causing one or more computing devices to: determine the subset of files by applying the filter parameters to the plurality of files; tag an individual file, of the subset of files, with the file management label to define an individual tagged file that is assigned with both the file retention period and the file purge age; prevent, at a first time, the individual tagged file from being purged from at least one storage device based on the file retention period; and purge, at a second time that is subsequent to the first time, the individual tagged file from the at least one storage device based on the individual tagged file reaching the file purge age.

Example Clause B, the computer-implemented method of Example Clause A, wherein the plurality of user interface elements is configured to enable the user to define both the file retention period and the file purge age for association with the file retention label.

Example Clause C, the computer-implemented method of any one of Example Clauses A through B, wherein the plurality of user interface elements is configured to enable the user to define at least: a first filter parameter to selectively activate the file management label with respect to a first productivity platform; and a second filter parameter to selectively activate the file management label with respect to a second productivity platform.

Example Clause D, the computer-implemented method of any one of Example Clauses A through C, further comprising obtaining account data corresponding to a plurality of user accounts that are provisioned with access to at least the first productivity platform and the second productivity platform, wherein the plurality of user interface elements is configured to enable the user to define a third filter parameter to selectively activate the file management label for a subset of user accounts, of the plurality of user accounts, with respect to the first productivity platform and the second productivity platform.

Example Clause E, the computer-implemented method of any one of Example Clauses A through D, further comprising: receiving, from the at least one computing device, a request to indicate a document fingerprint to associate with the file management label; generating, based on the request, at least one particular user interface element that is configured to enable the user to indicate at least one filter parameter that corresponds to the document fingerprint; and causing the one or more computing devices to automatically tag the individual file with the file management label based on a determination that the individual file matches the document fingerprint.

Example Clause F, the computer-implemented method of any one of Example Clauses A through E, further comprising: receiving, from the at least one computing device, a request to indicate a user-defined search query to associate with the file management label; generating, based on the request, at least one particular user interface element that is configured to enable the user to indicate at least one filter parameter that corresponds to the user-defined search query; causing the one or more computing devices to automatically tag the individual file with the file management label based on a determination that the individual file matches the user-defined search query.

Example Clause G, the computer-implemented method of any one of Example Clauses A through F, further comprising: receiving, from the at least one computing device, a request to indicate a sensitive information type to associate with the file management label, wherein the sensitive information type is associated with at least one regular expression; generating, based on the request, at least one particular user interface element that is configured to enable the user to indicate at least one filter parameter that corresponds to the sensitive information type; causing the one or more computing devices to automatically tag the individual file with the file management label based on a determination that the individual file contains at least one content item that satisfies the at least one regular expression.

While Example Clauses A through G are described above with respect to a method, it is understood in the context of this document that the subject matter of Example Clauses A through G can also be implemented by a device, by a system, and/or via computer-readable storage media.

Example Clause H, a system comprising: at least one processor; and at least one memory in communication with the at least one processor, the at least one memory having computer-readable instructions stored thereupon that, when executed by the at least one processor, cause the at least one processor to: obtain account data corresponding to a plurality of user accounts that are provisioned with access to at least one productivity platform; receive, from a computing device, at least one request to define one or more filter parameters for selective activation of a file management label; generate, based on the at least one request, graphical user interface data to cause the computing device to display a graphical user interface that includes at least one user interface element (UIE) that enables a user to generate selection data to: define a subset of user accounts of the plurality of user accounts, and set, for the file management label, both a file retention period and a file purge age; and based on the selection data, enable the file management label to be associated with individual files that are stored in association with the subset of user accounts and the at least one productivity platform to: prevent the individual files from being purged from at least one storage device based on the file retention period, and cause the individual files to be purged from the at least one storage device based on the individual files reaching the file purge age.

Example Clause I, the system of Example Clause H, further comprising: receiving, from a client device, user credentials corresponding to an individual user account of the plurality of user accounts; identifying at least one file that corresponds to the individual user account and the at least one productivity platform; and based on a determination that the individual user account is included within the subset of user accounts, causing a file labeling UIE to be displayed, at the client device, to enable the file management label to be manually associated with the at least one file.

Example Clause J, the system of any one of Example Clauses H through I, wherein the at least one UIE is configured to enable the user to generate the selection data to set an age threshold for association with the file retention label, and wherein the age threshold defines both the file retention period and the file purge age.

Example Clause K, the system of any one of Example Clauses H through J, wherein the at least one UIE is configured to enable the user to generate the selection data to set a first age threshold that defines the file retention period and a second age threshold, that is different than the first age threshold, that defines the file purge age.

Example Clause L, the system of any one of Example Clauses H through K, wherein the account data indicates a plurality of predefined organization groups that correspond to groupings of the plurality of user accounts, and wherein the at least one UIE is configured to enable the user to selectively activate the file management label with respect to an individual predefined organizational group of the plurality of predefined organizational groups.

Example Clause M, the system of any one of Example Clauses H through L, wherein the at least one UIE is further configured to enable the user to selectively de-activate the file management label with respect to one or more individual user accounts that are included within the individual predefined organizational group.

Example Clause N, the system of any one of Example Clauses H through M, wherein the computer-readable instructions further cause the at least one processor to: determine that at least some of the individual files have reached a purge review age that is less than or equal to the file purge age; and prompt at least one human reviewer to generate an indication of whether to purge the at least some of the individual files, wherein purging the at least some of the individual files is contingent on the indication.

Example Clause O, the system of any one of Example Clauses H through N, wherein the computer-readable instructions further cause the at least one processor to: determine a user access frequency for at least one particular file that is associated with the file management label and has reached the file purge age; and based on the user access frequency reaching or exceeding a threshold, prevent the at least one particular file from being automatically purged from the at least one storage device.

While Example Clauses H through O are described above with respect to a system, it is understood in the context of this document that the subject matter of Example Clauses H through O can also be implemented by a device, via a computer-implemented method, and/or via computer-readable storage media.

Example Clause P, a computer-readable storage medium having computer-executable instructions stored thereupon which, when executed by one or more processors of one or more computing devices, cause the one or more processors to: generate graphical user interface data to cause a display of at least one user interface element (UIE) that is configured to enable a user to: assign a file management rule with at least a file retention period and a file purge age; and indicate filter parameters for filtering a plurality of files that correspond to at least one productivity platform to identify a subset of files for selective application of the file management rule; receive a request to delete an individual file, of the subset of files, from at least one storage device associated with the at least one productivity platform; determine that the individual file satisfies one or more conditions of the file management rule; deny, at a first time, the request to delete the individual file from the at least one storage device based on a first determination that an age of the individual file corresponds to the file retention period; and automatically purge, at a second time that is subsequent to the first time, the individual file from the at least one storage device based on a second determination that the age of the individual file has reached the file purge age.

Example Clause Q, wherein the at least one UIE is further configured to enable the user to define the one or more conditions of the file management rule by selecting a first UIE to indicate condition parameters for one or more predetermined condition types, or selecting a second UIE to generate a user-defined search query, or both.

Example Clause R, the computer-readable storage medium of any one of Example Clause P through Q, wherein the at least one UIE is further configured to enable the user to associate at least one document template with the file management rule, and wherein determining that the individual file satisfies the one or more conditions of the file management rule includes determining that the individual file was created based on the at least one document template.

Example Clause S, the computer-readable storage medium of any one of Example Clauses P through R, wherein the computer-executable instructions cause the one or more processors to prevent, subsequent to the request to delete the individual file and prior to purging the individual file from the at least one storage device, the particular file from being displayed on a user device in association with the at least one productivity platform.

Example Clause T, the computer-readable storage medium of any one of Example Clauses P through S, wherein each of the file retention period and the file purge age correspond to a retention age threshold.

While Example Clauses P through T are described above with respect to a method, it is understood in the context of this document that the subject matter of Example Clauses P through T can also be implemented by a device, by a system, and/or via computer-readable storage media.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Furthermore, as used in the claims, the term “at least one computing device” and the term “one or more computing devices” being used within a single claim is not to be construed as a single element. For example, a system may cause “at least one computing device” to perform some actions and “one or more computing devices” to perform other actions. In some implementations, the “at least one computing device” may share some of all of the individual devices with the “one or more computing devices.” For example, the “at least one computing device” wholly or partially overlap with the “one or more computing devices.” In some embodiments, no single computing device of the “at least one computing device” is shared with or otherwise common to the “one or more computing devices.”

What is claimed is:

1. A computer-implemented method, comprising:
generating graphical user interface data to cause at least one computing device to display a graphical user interface that includes a plurality of user interface elements that are configured to enable a user to indicate filter parameters for determining, from a plurality of files that correspond to at least one productivity platform, a subset of files for selective activation of a file management label, wherein the file management label is associated with both a file retention period and a file purge age;
receiving, from the at least one computing device, selection data that is generated based on activation of at least some of the plurality of user interface elements to indicate the filter parameters; and
selectively activating, based on the selection data, the file management label with respect to the subset of files by causing one or more computing devices to:
determine the subset of files by applying the filter parameters to the plurality of files;
tag an individual file, of the subset of files, with the file management label to define an individual tagged file that is assigned with both the file retention period and the file purge age;
prevent, at a first time, the individual tagged file from being purged from at least one storage device based on the file retention period; and
purge, at a second time that is subsequent to the first time, the individual tagged file from the at least one storage device based on the individual tagged file reaching the file purge age.

2. The computer-implemented method of claim 1, wherein the plurality of user interface elements is configured to enable the user to define both the file retention period and the file purge age for association with the file retention label.

3. The computer-implemented method of claim 1, wherein the plurality of user interface elements is configured to enable the user to define at least:
a first filter parameter to selectively activate the file management label with respect to a first productivity platform; and
a second filter parameter to selectively activate the file management label with respect to a second productivity platform.

4. The computer-implemented method of claim 3, further comprising obtaining account data corresponding to a plurality of user accounts that are provisioned with access to at least the first productivity platform and the second productivity platform, wherein the plurality of user interface elements is configured to enable the user to define a third filter parameter to selectively activate the file management label for a subset of user accounts, of the plurality of user accounts, with respect to the first productivity platform and the second productivity platform.

5. The computer-implemented method of claim 1, further comprising:
receiving, from the at least one computing device, a request to indicate a document fingerprint to associate with the file management label;
generating, based on the request, at least one particular user interface element that is configured to enable the user to indicate at least one filter parameter that corresponds to the document fingerprint; and
causing the one or more computing devices to automatically tag the individual file with the file management label based on a determination that the individual file matches the document fingerprint.

6. The computer-implemented method of claim 1, further comprising:
receiving, from the at least one computing device, a request to indicate a user-defined search query to associate with the file management label;
generating, based on the request, at least one particular user interface element that is configured to enable the user to indicate at least one filter parameter that corresponds to the user-defined search query;
causing the one or more computing devices to automatically tag the individual file with the file management label based on a determination that the individual file matches the user-defined search query.

7. The computer-implemented method of claim 1, further comprising:
receiving, from the at least one computing device, a request to indicate a sensitive information type to associate with the file management label, wherein the sensitive information type is associated with at least one regular expression;
generating, based on the request, at least one particular user interface element that is configured to enable the user to indicate at least one filter parameter that corresponds to the sensitive information type;
causing the one or more computing devices to automatically tag the individual file with the file management label based on a determination that the individual file contains at least one content item that satisfies the at least one regular expression.

8. A system, comprising:
at least one processor; and
at least one memory in communication with the at least one processor, the at least one memory having computer-readable instructions stored thereupon that, when executed by the at least one processor, cause the at least one processor to:
obtain account data corresponding to a plurality of user accounts that are provisioned with access to at least one productivity platform;
receive, from a computing device, at least one request to define one or more filter parameters for selective activation of a file management label;
generate, based on the at least one request, graphical user interface data to cause the computing device to display a graphical user interface that includes at least one user interface element (UIE) that enables a user to generate selection data to:
define a subset of user accounts of the plurality of user accounts, and
set, for the file management label, both a file retention period and a file purge age; and
based on the selection data, enable the file management label to be associated with individual files that are stored in association with the subset of user accounts and the at least one productivity platform to:
prevent the individual files from being purged from at least one storage device based on the file retention period, and
cause the individual files to be purged from the at least one storage device based on the individual files reaching the file purge age.

9. The system of claim 8, further comprising:
receiving, from a client device, user credentials corresponding to an individual user account of the plurality of user accounts;
identifying at least one file that corresponds to the individual user account and the at least one productivity platform; and
based on a determination that the individual user account is included within the subset of user accounts, causing a file labeling UIE to be displayed, at the client device, to enable the file management label to be manually associated with the at least one file.

10. The system of claim 8, wherein the at least one UIE is configured to enable the user to generate the selection data to set an age threshold for association with the file retention label, and wherein the age threshold defines both the file retention period and the file purge age.

11. The system of claim 8, wherein the at least one UIE is configured to enable the user to generate the selection data to set a first age threshold that defines the file retention period and a second age threshold, that is different than the first age threshold, that defines the file purge age.

12. The system of claim 8, wherein the account data indicates a plurality of predefined organization groups that correspond to groupings of the plurality of user accounts, and wherein the at least one UIE is configured to enable the user to selectively activate the file management label with respect to an individual predefined organizational group of the plurality of predefined organizational groups.

13. The system of claim 12, wherein the at least one UIE is further configured to enable the user to selectively de-activate the file management label with respect to one or more individual user accounts that are included within the individual predefined organizational group.

14. The system of claim 8, wherein the computer-readable instructions further cause the at least one processor to:
determine that at least some of the individual files have reached a purge review age that is less than or equal to the file purge age; and
prompt at least one human reviewer to generate an indication of whether to purge the at least some of the individual files, wherein purging the at least some of the individual files is contingent on the indication.

15. The system of claim 8, wherein the computer-readable instructions further cause the at least one processor to:
determine a user access frequency for at least one particular file that is associated with the file management label and has reached the file purge age; and
based on the user access frequency reaching or exceeding a threshold, prevent the at least one particular file from being automatically purged from the at least one storage device.

16. A computer-readable storage medium having computer-executable instructions stored thereupon which, when executed by one or more processors of one or more computing devices, cause the one or more processors to:
generate graphical user interface data to cause a display of at least one user interface element (UIE) that is configured to enable a user to:
assign a file management rule with at least a file retention period and a file purge age; and
indicate filter parameters for filtering a plurality of files that correspond to at least one productivity platform to identify a subset of files for selective application of the file management rule;
receive a request to delete an individual file, of the subset of files, from at least one storage device associated with the at least one productivity platform;
determine that the individual file satisfies one or more conditions of the file management rule;
deny, at a first time, the request to delete the individual file from the at least one storage device based on a first determination that an age of the individual file corresponds to the file retention period; and
automatically purge, at a second time that is subsequent to the first time, the individual file from the at least one storage device based on a second determination that the age of the individual file has reached the file purge age.

17. The computer-readable storage medium of claim 16, wherein the at least one UIE is further configured to enable the user to define the one or more conditions of the file management rule by selecting a first UIE to indicate condition parameters for one or more predetermined condition types, or selecting a second UIE to generate a user-defined search query, or both.

18. The computer-readable storage medium of claim 16, wherein the at least one UIE is further configured to enable the user to associate at least one document template with the file management rule, and wherein determining that the individual file satisfies the one or more conditions of the file management rule includes determining that the individual file was created based on the at least one document template.

19. The computer-readable storage medium of claim 16, wherein the computer-executable instructions cause the one or more processors to prevent, subsequent to the request to delete the individual file and prior to purging the individual file from the at least one storage device, the particular file from being displayed on a user device in association with the at least one productivity platform.

20. The computer-readable storage medium of claim 16, wherein each of the file retention period and the file purge age correspond to a retention age threshold.
